(19) United States
(12) Patent Application Publication
(10) Pub. No.: US 2010/0162126 A1
(43) Pub. Date: Jun. 24, 2010

(54) PREDICTIVE CACHE TECHNIQUES

(75) Inventors: Jesse Donaldson, Santa Clara, CA (US); Robert Tsuk, Cupertino, CA (US)

Correspondence Address: KACVINSKY LLC;4500 BROOKTREE ROAD, SUITE 102, WEXFORD, PA, 15090, US

(73) Assignee: Palm, Inc., Sunnyvale, CA (US)

(21) Appl. No.: 12/343,297

(22) Filed: Dec. 23, 2008

(51) Int. Cl. G06F 3/00

(52) U.S. Cl. 715/738

(57) ABSTRACT

Predictive caching techniques are described. An apparatus may include a document manager component having a document rendering module and a list manager module. The document rendering module may present a document for the active web application within a display area of an electronic display, the document having a set of list items stored by a list data object. The list manager module may select a set of presentable list items from the list data object for current presentation within the display area for the electronic display, select a set of predictive list items from the list data object for future presentation within the display area for the electronic display, and send a control directive to load the set of predicted list items from the list data object to a predictive cache. Other embodiments are described and claimed.

### RELATED APPLICATIONS

This application is related to the copending application by Chatterjee et al., entitled “Application Management Framework for Web Applications,” Ser. No. 12/181,776 filed on Jul. 29, 2008 which application is hereby incorporated by reference in its entirety.

### BACKGROUND

Web browsers have become highly capable software packages in recent years. In addition to rendering web pages, a web browser may run small applications, sometimes referred to as “widgets.” Many web browsers also support the ability to run more complex web applications in the web browser. Such web applications may be implemented using various web technologies such as HTML, XHTML, XML, and Asynchronous JavaScript and XML (Ajax).

Although a web application has many advantages, it suffers in a number of areas. For instance, web applications may generate documents with dimensions that exceed a typical display implemented for an electronic device executing the web browser and web application. This problem is exacerbated for electronic devices having smaller form factors and thereby smaller displays, such as a mobile telephone, smart phone, handheld computer, or the like. As such, the smaller electronic devices may force a web application to render and display only a limited portion of a document at any given moment in time. When a new portion of the document is needed for display, the web application may incur significant delay in rendering and displaying the new portion. The latency may degrade the user experience when attempting to view the document. It is with respect to these and other considerations that the present improvements have been needed.

### BRIEF DESCRIPTION OF THE DRAWINGS

FIG. 1 illustrates an embodiment of an application management framework.

FIG. 2 illustrates an embodiment of a computing device including a web browser and a Web Virtual Machine.

FIG. 3 illustrates an embodiment of a logic flow for initializing an application framework.

FIG. 4 illustrates an embodiment of a logic flow for handling events by an application framework.

FIG. 5 illustrates an embodiment of a mobile device including web application and application management framework user interfaces.

FIG. 6 illustrates an embodiment of a document manager component.

FIGS. 7A-7B illustrate embodiments of a web application interface.

FIG. 8 illustrates an embodiment of a communications network.

FIG. 9 illustrates an embodiment of a logic flow.

### DETAILED DESCRIPTION

Various embodiments are generally directed to an application management framework for web applications that may provide speed improvements, capability improvements, user experience improvements, and simplified application development to wide range of network devices. The described embodiments may employ techniques for containing, controlling, and presenting multiple web-based applications in a shared web browser application management framework. Such techniques are particularly well-suited to mobile devices, such as cellular phones, that have limited processing capabilities, intermittent access to a network, small display screens, and limited user input capabilities.

Sharing a web browser application management framework provides the capability for rapidly switching between applications, allows for multitasking, facilitates using a common set of input controls for applications, and makes it possible for applications to be available with little perceived startup (“boot”) time.

Furthermore, applications within the shared web browser application management framework may have access to the additional capabilities provided by the framework, such as caching of content or data for offline access, providing for updates to the contained applications, and accessing native services of the mobile device such as calendar or contact data. The described embodiments also provide incentives for web application users, web application developers, and web application portal providers to share in transactions between one another.

In various embodiments, one class of additional capabilities provided by the shared web browser application management framework may include providing access to various predictive caching techniques. For instance, web applications may generate documents with dimensions that exceed a typical display implemented for a mobile computing device. As such, the mobile computing device may force a web application to render and display only a limited portion of a document at any given moment in time. When a new portion of the document is needed for display, the web application may need to access and retrieve data for the document from a memory unit. Memory access times, however, may vary considerably in accordance with a number of factors, such as the type of memory used to store the data (e.g., volatile or non-volatile memory), whether the data is stored in internal or external memory for the mobile computing device (e.g., system memory or removable storage cards), whether the data is stored by an external device such as a server, and other memory access factors. Consequently, a web application attempting to retrieve data for a new portion of the document needed for display may experience slower memory access times, which may be potentially undesirable to a user.

To solve these and other problems, various embodiments may implement techniques for rendering portions of a document (e.g., web page) used by a web application based on an amount of available display area for an electronic device. In particular, various embodiments may implement predictive cache techniques to improve memory access times when rendering and displaying a document for a web application. Some embodiments may decrease memory access times by implementing various caching techniques. For instance, some embodiments may move data for a document used by a web application from storage media with slower access times to storage media with faster access times, such as an L1 or L2 memory cache stored on the same die as the processor, or accessible via a high-speed memory bus. Furthermore, some embodiments may use a predictive cache algorithm to selectively cache predicted data from a document used by a web application that has a higher probability of presentation by an electronic display, such as a touch-screen display for a mobile computing device. Consequently, a web application attempting to render and display information for a document stored by slower memory units may realize increased memory access performance by retrieving the information from a cache using faster memory units, rather than from the slower memory units. Accordingly, a user may experience reduced latency when attempting to scroll through a document for a web application.

Numerous specific details are set forth to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

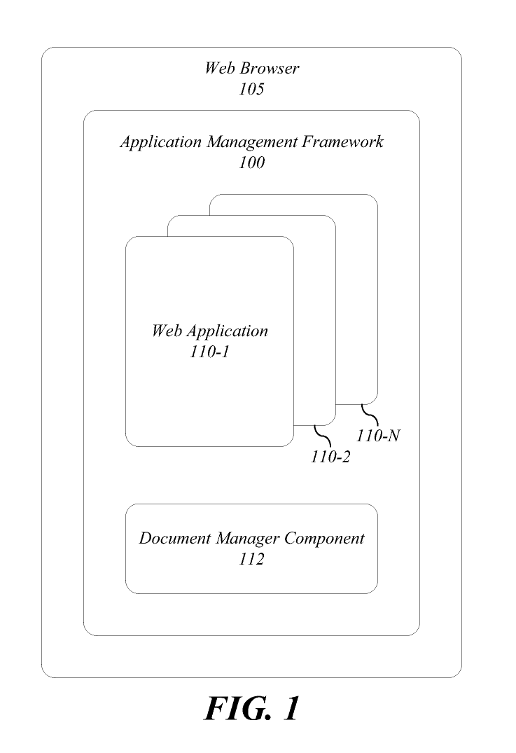

FIG. 1 illustrates an architectural view of an application management framework 100 suitable for implementing various embodiments. Although FIG. 1 may show a limited number of components by way of example, it can be appreciated that a greater or a fewer number of components may be employed for a given implementation.

In various embodiments, the application management framework 100 may be implemented by a computing device. Elements of the computing device may comprise various physical and/or logical components for communicating information which may be implemented as hardware components (e.g., computing devices, processors, logic devices), executable computer program instructions (e.g., firmware, software) to be executed by various hardware components, or any combination thereof, as desired for a given set of design parameters or performance constraints. Exemplary computing devices may include a personal computer (PC), desktop PC, notebook PC, laptop computer, mobile computing device, smart phone, personal digital assistant (PDA), mobile telephone, combination mobile telephone/PDA, video device, television (TV) device, digital TV (DTV) device, high-definition TV (HDTV) device, media player device, gaming device, messaging device, or any other suitable communications device in accordance with the described embodiments.

The computing device comprising the application management framework 100 may form part of a wired communications system, a wireless communications system, or a combination of both. For example, the computing device may be arranged to communicate information over one or more types of wired communication links such as a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The computing device may be arranged to communicate information over one or more types of wireless communication links such as a radio channel, satellite channel, television channel, broadcast channel infrared channel, radio-frequency (RF) channel, Wireless Fidelity (WiFi) channel, a portion of the RF spectrum, and/or one or more licensed or license-free frequency bands. In wireless implementations, the computing device may comprise one more interfaces and/or components for wireless communication such as one or more transmitters, receivers, transceivers, amplifiers, filters, control logic, wireless network interface cards (WNICs), antennas, and so forth. Although certain embodiments may be illustrated using a particular communications media by way of example, it may be appreciated that the principles and techniques discussed herein may be implemented using various communication media and accompanying technology.

As shown in FIG. 1, the application management framework 100 may be implemented by and run within a web browser 105. The web browser 105 may be implemented by a desktop and/or mobile version of a web browser such as Internet Explorer®, Mozilla®, Firefox®, Safari®, Opera®, Netscape Navigator®, and/or any other suitable web browser in accordance with the described embodiments. In various embodiments, the web browser 105 may support the computer programming languages, standards, web protocols, and/or technologies required by the application management framework 100. Such computer programming languages, standards, web protocols, and/or technologies may include, but are not limited to, HTML, XHTML, XML, Flash®/ActionScript, Macromedia® Flash®, JavaScript, ECMAScript, JScript, Basic, Visual Basic®, Visual Basic® Scripting Edition(VBScript), CSS, Asynchronous JavaScript and XML(Ajax), Flex®, Java®, Python, Perl®, C#/.net, Flash®, and/or other suitable programming, scripting, or VM-based languages. In addition, the web browser 105 may support “local” surfing, where “localhost” resources may be accessed with no requirement for connectivity to a network. It can be appreciated that some present day web browsers may attempt to connect to a network even when only localhost resources are needed, which may interfere with the operation of some embodiments.

In various implementations, the web browser 105 may provide the basis of the user interface and may include a language interpreter such as a script interpreter for computer programming languages such as JavaScript®, Flash®, VBScript, and/or other scripted programming languages where browser-based scripts, bytecode sets, or languages are interpreted in real time by runtime interpreter. The web browser 105 may provide a platform for running web applications in the web browser 105 using various web technologies such as HTML, XHTML, XML, Asynchronous JavaScript and XML (Ajax), and so forth.

In general, the application management framework 100 may be written in any computer programming language supported by the web browser 105 such as in one or more programming, scripting, or Virtual Machine (VM) based languages. For example, various standard web technologies such as HTML, CSS, JavaScript, ECMAScript may be applied to create the application management framework 100. Since many web page authors are familiar with these technologies, the benefits of using the application management framework will be readily apparent. It can be appreciated that development using web technologies is generally much faster and easier than is the case for specialized native programming languages such as C, C++, and so forth. Further, such native programming languages often require expensive development tools for mobile devices. For web applications, however, a wide array of freely available or inexpensive software development tools makes web application development possible for a much larger community of developers.

As shown, the application management framework 100 may comprise and encapsulate one or more web applications such as web applications 110-1 through 110-N, where N is any suitable positive integer value in accordance with the described embodiments. The web applications 110-1 through 110-N each may be written in any language supported by the web browser 105. The source code for the web applications 110-1 through 110-N and for the application management framework 100 may be highly portable across a wide array of hardware and software platforms such as desktop computers, mobile phones, and so forth. Additionally, a central server can pre-load the set of web applications 110-1 through 110-N into the application management framework 100 and serve the entire application management framework 100 to many computing devices. In some embodiments, the web applications 110-1 through 110-N may comprise or be implemented within the application management framework 100 as one or more mini applications or widgets.

The application management framework 100 may allow a user to switch between and among the web applications 110-1 through 110-N quickly without having to re-launch the web browser 105 or HTML application environment. In various implementations, for example, a plurality of the web applications 110-1 through 110-N may run simultaneously within the application management framework 100. In one embodiment, the web applications 110-1 through 110-N may run in an HTML “iframe” within the application management framework 100. When multiple web applications are already running and resident in memory, switching between and among the web applications generally requires very little time, thereby improving the user experience.

The application management framework 100 may capture user interaction events, such as mouse clicks, stylus clicks, keyboard input, jog wheel input, touchscreen input, voice input, button input, and so forth. The application management framework 100 may selectively pass one or more captured events to one or more of the web applications 110-1 through 110-N contained in the application management framework 100. This facilitates creation of a group of web applications that together have a common set of user input controls. Additionally, it simplifies web application development for devices with limited input controls. For example, on a mobile telephone it is advantageous to permit control of a web application with one finger. In various embodiments, the application management framework 100 may support the ability of a user to switch between and among the web applications 110-1 through 110-N quickly using a single finger or “mouseover” action providing for a pleasant user experience.

The application management framework 100 may control aspects of the one or more of the contained web applications 110-1 through 110-N. For example, the application management framework 100 may control which web applications is visible to the user at a given time, whether a web application is actively processing data, and/or when to direct a web application to be “refreshed” or reloaded into the web browser 105. The application management framework 100 also may prompt one or more of the contained web applications 110-1 through 110-N to reload or update its data.

In various implementations, the application management framework 100 may provide a mechanism for developers to incorporate multitasking into one or more of the web applications 110-1 through 110-N. For example, by programmatically “hiding” a web application using a hidden frame, the application management framework 100 may allow a web application to run in the background while the user sees the user interface of a different web application.

The application management framework 100 also may provide a mechanism by which the web applications 110-1 to 110-N may accelerate document rendering and display operations for a mobile computing device. The application management framework 100 may include a document manager component 112. The document manager component 112 may implement various predictive cache techniques to improve memory access times when rendering and displaying a document for one or more of the web applications 110-1 to 110-N. Although the document manager component 112 may be described as implemented by the application management framework 100 in some embodiments, it may be appreciated that the document manager component 112 may be implemented by other parts of a mobile computing device, such as an integrated part of web browser 105, or one of the web applications 110-1 to 110-N. The embodiments are not limited in this context.

The document manager component 112 may implement various predictive cache techniques to decrease memory access times for rendering and displaying a document for a web application 110-1 to 110-N. The document manager component 112 may utilize a predictive cache algorithm to identify data that has a higher probability of being displayed on an electronic display. The document manager component 112 may then move, transfer or otherwise cache the predicted data for a document used by a web application 110-1 to 110-N from storage media with slower access times to storage media with faster access times. For instance, the document manager component 112 may move data for some or all of a document to a special purpose cache. Once the data is stored in the special purpose cache, future use can be made by accessing the cached copy rather than refetching or recomputing the original data, thereby lowering memory access times. The special purpose cache may comprise, for example, an L1 or L2 memory cache stored on the same die as a processor, or accessible via a high-speed memory bus. The special purpose cache may be managed by a cache manager under the direction of the document manager component 112.

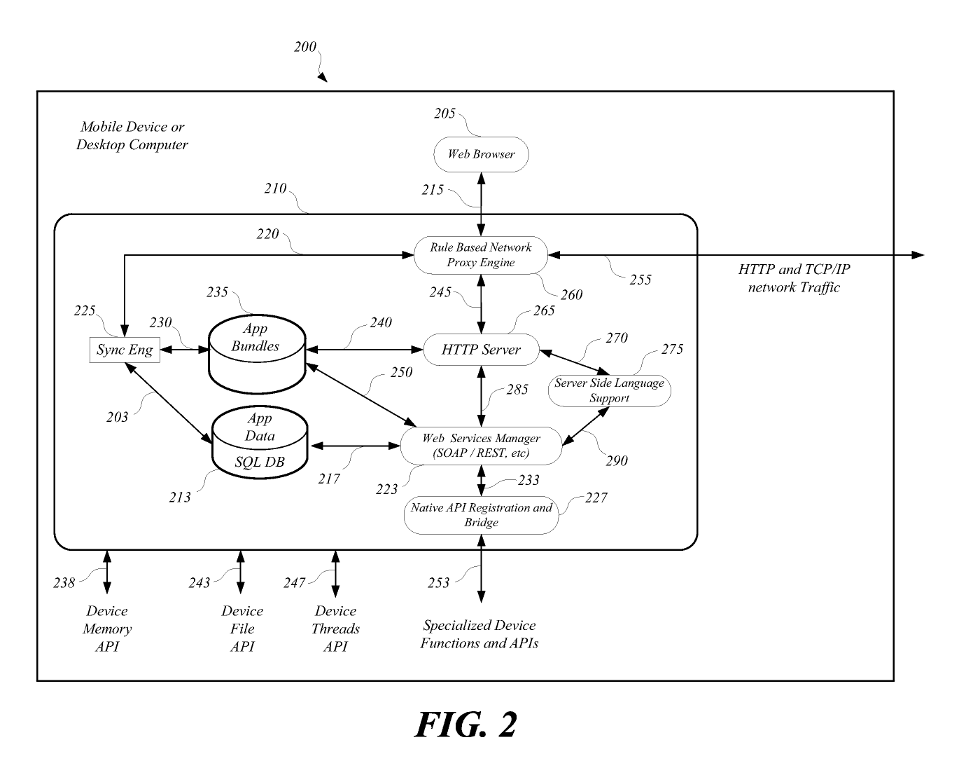

The document manager component 112 may use a predictive cache algorithm to selectively cache data for a document used by a web application 110-1 to 110-N that has a higher probability or likelihood of presentation by an electronic display, such as a touch-screen display for a mobile computing device. Consequently, a web application 110-1 to 110-N attempting to render and display information for a document stored by slower memory units may realize increased memory access performance by retrieving the information from a cache rather than the slower memory units. For instance, the document manager component 112 may use the predictive cache algorithm to identify and select all data surrounding a portion of displayed data, and cache the surrounding data in a predictive cache. When a user operates an input device to scroll from the displayed data towards a set of surrounding data in a given spatial direction (e.g., up, down, left, right), the document manager component 112 may load the surrounding data from the predictive cache rather than external memory (e.g., non-volatile memory). Accordingly, a user may experience reduced latency when attempting to scroll through a document for a web application, particularly when the boundary of the document exceeds the display area available for a given display device. The application management framework 100 in general, and the document manager component 112 in particular, may be described in more detail with reference to FIGS. 2-8.

FIG. 2 illustrates a computing device 200 suitable for implementing various embodiments. In the illustrated embodiment shown in FIG. 2, the computing device 200 may comprise a web browser 205 and a Web Virtual Machine (WebVM) 210. In various implementations, the application management framework 100 may interact with the web browser 205, as described herein. In such implementations, the capabilities of the application management framework 100 may be combined with the capabilities of the WebWM 210.

In general, the WebVM 210 may implement a local web host to provide server functionality on the computing device 200 and to serve local applications to the web browser 205. When implemented as a server on the computing device 200, the WebVM 210 may support and provide access to multiple applications. The WebVM 210 may run server side code such as PHP, Python, PERL or CGI programming environments locally on the computing device 200. The WebVM 210 also may implement web methods programming interfaces and web services extensions via SOAP, XML RPC, REST, and the like for enabling access to local resources of the computing device 200. Accordingly, the computing device 200 may provide server side interfaces to access local resources such as a file system, a phonebook, a media store, a database, a hardware component (e.g., camera, microphone, etc.), a software component, and/or other controlled resource of the computing device 200. Such interfaces also may implement server side code for allowing the user to write to a local resource such as a phonebook, media store, and so forth.

The WebVM 210 may implement security measures such as secure HTTP (https) and/or other login methods to obtain user authentication for preventing unauthorized access and use of the applications and/or other resources. The WebVM 210 may be configured to intermediate between the applications on the computing device 200 and the web browser 205 to broker local services and ensure that only a trusted entity is given access to specific functionality. The WebVM 210 also may implement various web based security models and access restrictions for evaluating function calls from a web browser which request access to local resources of the computing device 200.

When combined with the WebVM 210, the application management framework 100 may provide several additional advantages. For example, one or more of the web applications 110-1 through 110-N within the application management framework 100 may interact with local web applications or native applications running on a local server within the WebVM 210, all within the computing device 200 itself. This is advantageous during times when the computing device 200 is not connected to a network, or when there is a need to store data from a web application locally on the computing device 200. In various embodiments, resident or nonresident web applications such as widgets may include the ability to publish a notify to a home screen of the computing device via an offline proxy implemented by the WebVM 210.

Additionally, a web application within the application management framework 100 may utilize the proxy services of the WebVM 210 to access data or services from a different website than the website from which the initiating web application originated. Generally, the “origin policy” used for web applications prevents this behavior such that a script running in a web browser is only able to access or modify data at the website from which the script originated. The application management framework 100, when combined with the WebVM 210, provides a mechanism to work around this limitation. A suitable security policy may then be implemented within the WebVM 210.

Furthermore, the WebVM 210 can cache frequently needed data so that it is immediately available to a web application, without requiring the user to wait to access the data using the network. This vastly improves the overall user experience, so that it feels to the user that data is always available, even if the connection to the network is low or unavailable.

FIG. 2 depicts one possible implementation of a WebVM 210 configured to run on a computing device 200 such as mobile device (e.g., mobile device 100) or desktop computer. In various embodiments, the Web Virtual Machine (WebVM) 210 may be implemented as described in U.S. patent application Ser. No. 11/612,282 titled “System for Running Web Applications Offline and Providing Access to Native Services,” which was filed on Dec. 18, 2006 and is entirely incorporated by reference.

As shown, the WebVM 210 interacts directly with the web browser 205 via a connection 215, which may be implemented as an http network connection which runs on the computing device 200. Typically this can be invoked by the web browser 205 connecting to a local host IP address (e.g., 127.0.0.1) or other suitable addresses or address and port combinations. Accordingly, different applications may be served by the WebVM 210 simultaneously on the different address port combinations and at different security levels with each application having different permissions levels and access rights to local resources.

The WebVM 210 connects to device services through application programming interfaces (APIs) including Device Memory API 238, Device File API 243, Device Threads API 247, and Specialized Device Functions and APIs 253. It is noted that WebVM 210 uses APIs 238, 243, and 247 to connect resources that facilitate internal operation such as memory access, file system, and task/threading and are also used for porting of the WebVM 210 among different classes of devices and operating systems.

The interface 253 may be implemented as one or more meta-interfaces which represent the expandable nature of the WebVM 210. Using SOAP, REST, or other web services bindings, web programs running either in the WebVM 210 or via the web browser 205, such as through Ajax, can access special services to the computing device 200. For example, the computing device 200 may include a phonebook or a digital media store for an on-device camera available as a C++ or Java service. By using the interfacing capabilities of the WebVM 210 through the interface 253, it is possible to let web applications run locally on the computing device 200 (e.g., mobile device or desktop computer) without outside server dependencies to be able to access local services and maintain a client-server programming model based on web programming techniques and with web security models intact. For example web-based phone book application could access the local phonebook on the computing device 200 via the interface 253 and then store associations locally in an a local SQL database 213 to create hybrid functionality. Later the same web application can send or store the phonebook information retrieved via interface 255 to an online web portal on the internet.

In operation, the WebVM 210 operates several portions of an http server stack as depicted by the interaction of the web browser 205 and a network proxy 260 through a path 215. The network proxy 260 may comprise a rule based network proxy engine implementing a software stack which redirects incoming network traffic either to the outside world via an interface 255 or towards an http server 265 via a path 245. For example, a browser-based application authored in XHTML and running a local scripting language (in the web browser 205) such as JavaScript or VBScript may request a new resource such as a new page or an XMLHttpRequest type data call. This request will be brokered from the web browser 205 through the network proxy 260 to the http server 265 for handling. If the request is for a web page or similar addressable asset, the http server 265 can then pull the resource and serve it back to the web browser 205. The http server 265 can fetch the resource from one of several local objects including a locally mounted file system implemented by the http server 265 and a local application bundle manager 235 which is connected to the http server 265 via a path 240.

If the request is a data call or a callback function to a server side scripting language (e.g., PHP, Python, Java Enterprise Edition, servlets or Common Gateway Interface Scripts), the http server 265 will hand the request off to a processing engine. In the case of a server side scripting language, the request is handed via a path 270 to a server side language support processing engine 275 which handles the request, provides language specific features, and maintains session management information or server side variables. If the request is via web description language interface (e.g., SOAP, WSDL, REST, XML remote procedure call, or similar function), then the request can be handed off via a path 285 to a specialized web services manager 223 which functions as previously mentioned to complete the request functionality. It is also possible to use the server side language support processing engine 275 to complete the call via a path 290 to the specialized web services manager 223 thereby enabling either Ajax only applications (e.g. applications which only have browser-based code and logic) or server-based code and logic to share SOAP/REST/Web services plug-ins.

The WebVM 210 also can provide access to a local SQL database 213 which is connected to the web services manager 223 via a path 217. The local SQL database 213 provides the ability to store end user data such as preferences, location, or profile information. Applications running in the web browser 205 can access the local SQL database 213 via server side scripts running in the server side language support processing engine 275 or via a direct web services software call (e.g., SOAP call) which is issued directly through the web services manager 223. The local SQL database 213 also connects to a data synchronization engine 225 via a path 203. Application resources are stored as application bundles in a database implemented by the application bundle manager 235 which is directly connected via a path 240 to the http server 265. The database implemented by the application bundle manager 235 is also connected to the data synchronization engine 225 via a path 230.

In various implementations, an application bundle 225 can also be fully serviced with or without the HTTP server component by using a message passing interface 250 to interact with the web services manager 223. This allows applications to have direct non-socket based services fulfilled to access local hardware or storage in an efficient manner. Examples of interface 250 may comprise intra-message passing frameworks such as the Linux DBus or other suitable message passing framework. For example, the web services manager 223 may communicate with the application management framework 100 over a direct message passing interface. In this model the application environment is dedicated—not just the browser, but browser-like. In other words, a browser rendering engine, such as a webkit renders HTML along with helper libraries for executing JavaScript/ECMAscript but it is not the browser application per se. That is, the user does not realize they are in a browser environment.

The application bundle manager 235 manages entire web application assets. An application may be served from a web archive comprising a collection of the necessary application files for a web application. The web archive file may comprise a bundle or package of the web assets of the web application including index files, HTML files, script files (e.g., JavaScript or server script such as PHP, Python or Perl), graphics (e.g., JPEGs, GIFs), animations, directories, and other web application components. The web archive can be packaged, stored, and compressed using file archiving libraries such as zip, gzip or zlib, or other suitable packing schemes.

When a request is made to a particular file which may be stored as a part of an atomic bundle comprising the application assets, the network proxy 260, the http server 265, and the application bundle manager 235 work in succession to resolve the file just as if it had been hosted on an Internet server. These components also work to resolve same origin policy security enforcement in much the same way that a browser cache does. In other words, xyz.foo.com/mypage.xhtml can be stored locally but accessed in a programmatic way rather than as the browser cache which acts in an automatic (non-programmatically controlled) method. Universal Resource Locators (URLs) which explicitly resolve to local addresses (such as ports running on 127.0.0.1, the http loopback address) resolve and are served to the local web browser 205 via the http interface 210. In some cases, the web browser 205 may not be explicitly aware of the location which actually serves the file.

Additional functionality of the WebVM 210 is provided by using the synchronization engine 225 to update the locally stored applications, such as those stored in the database of the application bundle manager 235 and in the local SQL database 213 via paths 230 and 213, respectively. This allows applications stored as bundles to be atomically stored on the computing device 200 as a single file. The synchronization engine 225 can then manage the storage, updating, upgrading, and subscription status of several such applications. For example a server could store information about a subscription application which the local synchronization engine 225 would enforce. When the subscription expires, the application bundle would be disabled or deleted. This functionality extends the type of application storage once associated with dedicated runtimes (e.g., Java Micro Edition) to web-based applications.

In addition, the synchronization engine 225 can store, synchronize and manage application data stored in the local SQL database 213. In a typical (server-based) application, user data (e.g., shopping cart information on an e-commerce based web store or photographs on a photo sharing website) would be stored on that database of that site. Via the WebVM 210, however, the ability to utilize web-based protocols to store application data locally is now available though web services calls. Moreover, the synchronization engine 225 can then move user data stored in the local SQL database 213 back to a classically running server at an Internet URL. The synchronization engine 225 therefore allows both applications and user data to be stored locally on the computing device 200. Should the computing device 200 be lost or the user acquire a newer, perhaps upgraded device, the applications and the application data for the user can be seamlessly re-provisioned to the new device.

The synchronization engine 225 also can access the external Internet through the network proxy 260 by using a path 220. This allows the synchronization engine 225 to move code assets and user and application data stored in the either the database of the application bundle manager 235 or local SQL database 213 and maintain them in accordance with business rules for subscription or provisioning of the user applications. Since it uses databases to store application bundles and user data, the WebVM 210 can also support different application permissions for different users allowing some to have access to more or different data than others.

The WebVM 210 also may implement various techniques as described in U.S. patent application Ser. No. 11/382,058 titled “Method for Synchronizing Software Application and User Data for Asynchronous Client-Server and Peer to Peer Computer Networks,” which was filed on May 8, 2006 and is entirely incorporated by reference. Accordingly, the WebVM 210 may support the creation of offline web applications and managing associated user data which is created offline that must later be reconciled with one or more central servers without a data collision. This provides knowledge of which version of different pieces of user data are new and which needs to be added to centralized servers. This applies to the actual web application program files so that software applications can be synchronized in addition to user data enabling a transparent online and offline user experience. Data sets can be distributed in manner which allows peer to peer synchronization and filedata distribution. The amount of transactional data required to synchronize data sets across a network can be minimized to increase efficiency of available bandwidth on a computer network.

The WebVM 210 also may implement an offline automated proxy cache as described in U.S. patent application Ser. No. 11/873,305 titled “Offline Automated Proxy Cache for Web Applications,” which was filed on Oct. 16, 2007 and is entirely incorporated by reference. The offline automated proxy cache may support scheduling and automatic repeating of requests for updated data. In various embodiments, scheduling parameters may be used to automatically retrieve updated versions of requested content behalf of a publishing application while the publishing application is offline (e.g., closed, runtime not running, VM not running, etc.). In such embodiments, the WebVM 210 may make repeated Ajax requests on behalf of the publishing application which are repeatedly scheduled to run, even when the publishing application is not running. The publishing parameters may comprise scheduling parameters including, for example, a time interval parameter that defines a time interval for requesting data updates, a history parameter defining a maximum number of versions of the data that may be cached simultaneously, a data expiry parameter specifying when data in the cache expires, a retry parameter defining a number of times to retry a connection, and others.

Repeating/auto-scheduled requests may be terminated by overwrite (e.g., if the publishing application sends an identical request with no scheduling parameters, then scheduling is removed), by explicit request deletion (e.g., if the publishing application sends a parameter to delete the published request via serial number then the auto scheduled request is removed), by application deletion (e.g., if the publishing application is deleted by the user or the operating system, then all autopublish, and proxy requests associated with the application are removed from the system), by programmatic flush (e.g., an API exists on the proxy publisher to suspend a given or all proxy-publish requests), and/or by timeout (e.g., if a given publishing application does not renew the proxy publish request in a given time such as two weeks, then the proxy publisher may allow the repeated proxy request to age out, stop repeating, and be deleted from the queue along with any stored data and rules).

In various embodiments, some or all the above publishing parameters may be wrapped in a namespace determined by the application using the WebVM 210. This namespace wrapping may be performed automatically. For example, if a publishing application such as MySuperWidget.wgt calls the WebVM 210, the stored query and request data will be put in a namespace or table which is prefixed by MySuperWidget. In this way different applications can store requests with the proxy, and the results will be kept separate to avoid naming conflicts (e.g., two different vendors using the same variable name). Reverse URL naming (e.g., com.lampdesk.MySuperWidget) is explicitly encouraged for some implementations. In addition, a public namespace also may be provided for intercommunication messaging.

The WebVM 210 also may implement an application runtime environment as described in U.S. patent application Ser. No. 12/019,362 titled “System and Methods for Providing Granular Security for Locally Running Scripted Environments and Web Applications,” which was filed on Jan. 4, 2008 and is entirely incorporated by reference. The application runtime environment may provide finer granularity and control at the function level rather then forcing an all or nothing approach to control over an application where the application either runs completely unfettered or is completely blocked from running. In particular, the application runtime environment may allow scripted runtime based applications to call local functions in a signed manner with function call level control.

With respect to web archives, the collection of web assets for a web application may be treated as a single file which can be signed and distributed in a secure fashion. A signing file (e.g., manifest file) may be automatically generated when bundling the web archive to provide details as to the APIs (e.g. SOAP calls) an application uses at signing when the application is registered with the certifying authority. When provided with a list of native functions to be used by an application, both the signing authority and the system where the application is eventually installed can compare functions that the application attempts to use against the list of functions which were signed and authorized. This provides an extra layer of security for the target operating system and implementation of system wide security policies to determine whether to allow an application to be installed and whether the functions that an application uses violate such policies.

The decision to execute a function call may be delegated in real-time to the operating system so that overall security is consistent with the blanket security policies of the operating system. By giving responsibility for allowing function calls to the operating system, platform level security control at the API level may be implemented across multiple runtime environments and requiring the runtime environments to only track which application is requesting what service. Accordingly, the operating system may maintain control of security and access for scripted applications and minimize the amount of security authority that must be deferred to the various application runtime environments.

The application runtime environment also may couple the signing process and installation of virtual machine or scripted runtime layer based applications back to core operating system in a unified way. In particular, the operating system may be involved in the accepting of signed scripted or bytecode based applications when granting permission to install an application. In addition, by using IP address and port address combinations, multiple separate web application running on the same local computing device may be tracked and kept separate. Accordingly, different security levels may be enforced among multiple applications running on the same device and application integrity may be persevered even if one of the applications is a “rogue” application.

The WebVM 210 also may implement a proxy publisher as described in U.S. patent application Ser. No. 12/116,697 titled “Automatic Conversion Schema for Cached Web Requests,” which was filed on May 7, 2008, which is entirely incorporated by reference. The proxy publisher may implement an automatic conversion schema which allows data results from a publishing application to be extracted and displayed by a display application other than the publishing application. For example, the proxy publisher may receive a request from a publishing application to retrieve a data result from a data server. The request may include a path to the data server and appended publishing parameters. In accordance with the automatic conversion schema, the publishing parameters may comprise decode parameters associated with the publishing application for allowing a display application other than the publishing application to decode variables of the data result and to transform the decoded variables for display. The proxy publisher may cache the request including the appended publishing parameters and retrieve the data result from the data server. The proxy publisher may locally store the data result along with the cached publishing parameters and may respond to a query from a display application for data associated with the publishing application by providing the cached data result and the publishing parameters to the display application.

In one exemplary embodiment, the publishing application may comprise an XHTML widget written in JavaScript and XHTML. The proxy publisher may receive a request (e.g., Ajax request) from the publishing application to retrieve a data result over the Internet from a remote data server. The request from the publishing application may include a path to the remote data server such a Uniform Resource Locator (URL) and appended publishing parameters.

The proxy publisher may process the request from the publishing application by caching the request including the appended publishing parameters and passing through the path to the remote data server. The remote data server may respond in normal fashion by returning a data result. The proxy publisher may receive the data result from the remote data server and process the data result by locally storing the data result with the cached publishing parameters for the publishing application.

The publishing parameters may comprise decode parameters associated with the publishing application for allowing a display application other than the publishing application to decode variables of the data result and to transform the decoded variables for display. The decode parameters may name the variables which can be extracted to publish a minimized representation of the publishing application. For example, a widget may publish a minimized representation of a weather application by releasing only the day's high temperature or a minimized representation of an e-mail application by releasing only the number of unread messages.

The decode parameters also may comprise data extraction rules and data formatting rules for instructing the display application how to extract web-request data (e.g. weather) from data result (e.g., response text), how to format the data (e.g. put this string+with the extracted web-request data), and how to display the data (e.g., display supplementary information such as a URL or text along with the response text).

Subsequently, the proxy publisher may receive a query from the display application. In some cases, the display application may request data from a specific named request. For example, the display application may request data associated with the publishing application. In other cases, the display application may ask the proxy publisher for a listing of all names for currently stored non-private (published) request data. By default, the proxy publisher may return all the named rules if the display application does not ask for a particular name.

Upon receiving an available name selected by the display application, the proxy publisher may provide a matching result including the locally stored data results and the publishing parameters to the display application. The display application may process the matching result by using the extraction rules to extract and decode the variables and using the formatting rules to display the extracted values in an appropriate manner. In some embodiments, the proxy publisher may reduce the processing required by the display application by extracting the variables from the data result using the data extraction rules and providing the extracted variables to the display application along with the data formatting rules.

In general, when the publishing application is a web-based application, the display application may be implemented as a viewer application or mobile device home screen outside of the web browser which cannot render standard web based content. For example, the display application may comprise a C/C++ active home screen, news aggregator, billboard, or mobile device ticker where only a small amount of information is displayed but that requires transformation of the cached data results to be usable. By using the decode parameters provided by the publishing application, the display application can transform the cached data into a format that it can use. Once the display application has obtained the variables in a usable format, the display application may republish the data in another format.

In accordance with the automatic conversion schema, the publishing parameters may comprise decode parameters for allowing the display application to decode variables of the data result and to transform the decoded variables for display. The decode parameters may comprise a name parameter (e.g., var_name) and a variable name for allowing the publishing application to name the variables extracted. The variable name may be used by outside applications to address a parameter left by the web application. The variable name may not be the name encoded in the offline proxy request, but it is the name (e.g., “Temp_Hi”) referred to by an outside application.

The decode parameters may comprise a data extraction rules parameter (e.g., extraction_rules, var_extract_regex) and instructions for extracting information from the response or data result. The publishing application may cause the proxy publisher to store, with the information request, instructions for extracting information from the response. The extracting instructions may be used by an outside application (e.g., display application) or the proxy publisher to extract (find) the information referred to by the name parameter (e.g., var_name) from the stored offline proxy request.

The extracting instructions may be implemented as a regular expression (regex) (e.g., JSON call): get_bytes[23-28] or a “capturing regular expression” in a server side scripting languages such as PERL regex. The extracting instructions also may be implemented via XPath or XQuery. The extracting instructions also may comprise an XSLT transformation. The extracting instructions also may comprise a custom program which is, in itself, the instructions for processing the request. For example, the stored instructions for extracting information from the data result may be implemented as an XHTML page containing JavaScript.

The decode parameters may comprise a data formatting rules parameter (e.g., formatting_rules) and instructions for displaying variables from the data result in a format used by an outside application (e.g., the display application). The publishing application may cause the proxy publisher to store, with the information request, a set of optional separate instructions for how to display and format the extracted data. The formatting instructions may comprise a string which is what an extracting application can display in an alert dialog. This parameter can be duplicated with different language parameters. The formatting instructions can be a transforming rule-set which takes the extracted value and displays it in a certain format (e.g. if 2007.04.11 is the date, then it is transformed via a regex to Apr. 11, 2007) such as via XSLT. The extraction instructions are used to extract the data returned by a server located at the URL formed by the calling application (e.g., publishing application), and the formatting instructions detail how the extracted data should appear in a certain application (e.g., display application) outside of the calling application.

The formatting instructions may be implemented by a regular expression (regex) separate from the regex used to extract the data. The formatting instructions also may comprise an XSLT transformation. The formatting instructions also may be implemented as a stored program in its own right. For example, the stored program is itself passed as a parameter which takes the extracted data and displays or formats the extracted data in a way which an outside application other than the calling application can use and process. For example, the stored program may comprise a scripted application such as XHTML+JavaScript. The display and formatting instructions also may be implemented by a custom language created for the purpose of formatting the extracted data. The display and formatting instructions also may be implemented by A C/C++ sprintf( ) capable string function parameter.

The decode parameters may comprise a private parameter (e.g., set_request_private) which may be implemented by a flag set so that the offline proxy request will not be readable by outside applications. The publishing application may deliberately not expose its data by directing the proxy to never honor a request from certain applications to provide security. As such, certain application may be prevented from receiving cached data results and publishing parameters for a given publishing application. Accordingly, the publishing application may make offline requests that are private (not shared) with other applications.

The publishing parameters may comprise event parameters or commands for asking the proxy publisher to perform actions on behalf of the application outside of request handling to allow web applications to behave as normal applications but with a background wakeup task. Whether the optional parameters can be executed is security level and operating system dependent. The event parameters may comprise a wake_upon (condition) parameter or command for requesting the proxy publisher to wake up (launch) an application when a certain offline proxy condition is met (e.g., e-mail received). Whether the application will actually be launched is left to security permissions or the operating system. The proxy publisher may implement an operating system service for sleeping applications to publish services which can be read and passed to other applications. For example, a C/C++ application can use the proxy publisher to post a request which self updates and presents a shared publishable result. In general, any compiled (statically linked) application can use the proxy publisher to wake up when a certain wake up condition is met.

The event parameters may comprise an alert_upon (condition) parameter or command for requesting the proxy publisher to post an alert to the operating system when a condition is met (e.g., publishing application needs attention). This allows a web application to post information via the proxy publisher. The response may be a posted message in a dialog box or a textual or iconic notification on the home screen/idle screen of the device. For example, a scripted widget application running on a cell phone device may provide an e-mail viewing service and may set an event such that when the proxy publisher discovers a new e-mail, an event request is posted to the device idle screen so that the user knows to look at their e-mail. The alert parameters also may comprise an optional alert_msg, parameter and an optional alert_urgency parameter.

The offline capabilities of a publishing application may be restricted in accordance with operating system security policies. For example, the proxy publisher may interact with the operating system security policies and permissions to restrict use of publishing application offline capabilities. In some embodiments, the proxy publisher will, for security purposes, include the application signature ID or referring page for the operating system to determine whether to execute a request in response to a wake up or alter condition.

The WebVM 210 also may be implemented as described in U.S. patent application Ser. No. 12/061,179 titled “System and Methods for Providing Access to a Desktop and Applications of a Mobile Device,” which was filed on Apr. 2, 2008 and is entirely incorporated by reference. Accordingly, one or more web applications hosted on the computing device 200 may be configured to be accessed by a web browser running on a terminal separate from the computing device 200. In various implementations, the UI displayed by the terminal may comprise an enhanced interface as compared to the UI of the computing device 200. For example, an application on a mobile device may be configured to serve up a UI comprising a phone-centric interface to the browser of the mobile device and configured to serve up a UI comprising an enhanced (e.g., larger/better/different) interface when connected to the browser of the terminal. In general, an application may serve a simplified interface to display on the mobile device and an enhanced interface to take advantage of the larger and/or more useful assets (e.g., larger screen, a full-size keyboard, a mouse, memory, browser plugins, hardware, etc.) of the terminal. For instance, an application on a mobile device which uses 4-way navigation and 2 soft keys when in a phone mode may serve an enhanced UI to the terminal that can use navigation hardware such as the full keyboard and mouse and that displays more content in the larger screen of the terminal.

The use of web-based technologies may allow a mobile device to deliver rich data applications such as small widgets or even conventional larger applications. In some cases, for example, a mobile device may be configured to host and run PC applications. In such cases, an enhanced version of the application may be run when accessed by the terminal while a simpler version of the application runs when accessed by the hosting mobile device. The application may be configured to support both environments without requiring modification of the application in the process. As such the application may detect its environment and run differently when used by the mobile device and when used by the terminal.

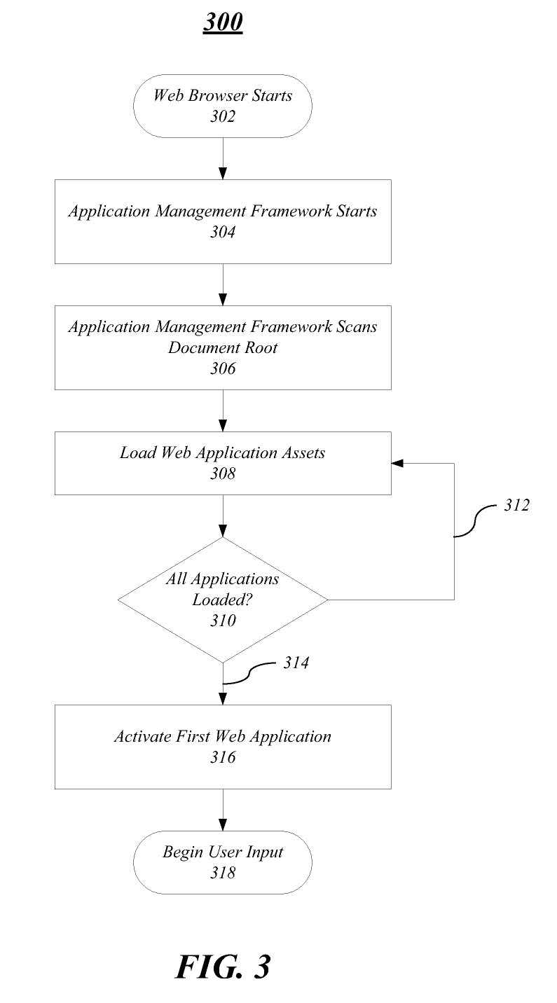

FIG. 3 illustrates one embodiment of a logic flow 300 for initializing the application management framework 100. The logic flow 300 may be performed by various systems and/or devices and may be implemented as hardware, software, firmware, and/or any combination thereof, as desired for a given set of design parameters or performance constraints. For example, one or more operations of the logic flow 300 may be implemented by executable programming instructions to be executed by a logic device (e.g., computer, processor).

In this embodiment, the user directs a web browser 105 to start the operation for initializing the application management framework 100 (step 302). For example, by starting the web browser 105 with command line arguments or by supplying a uniform resource identifier (URI), the user may specify the protocol, location, and name of the script for the application management framework 100. The web browser 105 uses this information to start the application management framework 100 (step 304).

In this exemplary embodiment, the application management framework 100 scans its document root to find available web application assets (step 306). The application management framework 100 then loads the web application assets for a first web application (step 308). If there are additional web applications available (step 310), the application management framework 100 repeats the process (step 312) for each web application. When all the web assets for all of the web applications have been loaded (step 314), the application management framework 100 activates the first web application (step 316) and prepares to receive user input events (step 318).

It can be appreciated that the logic flow 300 depicts an exemplary sequence for initializing the application management framework 100 and that alternative steps may be used to install one or more web applications in the application management framework 100. For example, in some cases, web applications may be inserted directly in the source code for the application management framework 100. Additionally or alternatively, the WebVM 210 may store one or more web publications to be loaded by the application management framework 100 at startup or upon request by the user.

In various embodiments, a list of web applications may be stored in “cookies” on the computing device of the user so that the web applications can be reloaded or configured. In some cases, the list of web applications may be served via server-side logic (e.g., SOAP, REST, JSON, etc.). Some embodiments may use server-side languages (e.g., PHP) to permit building of a web application launcher that may be customized by the user and/or by the web application developer. Certain embodiments also may allow saving of user preferences, configurations, or web application data into a database implemented locally on the device of the user (e.g., via the WebVM 210) or on a network server. In addition, the application management framework 100 may be compatible with “plug-in” technologies such as Adobe PDF, Flash®, VMRL, and others.

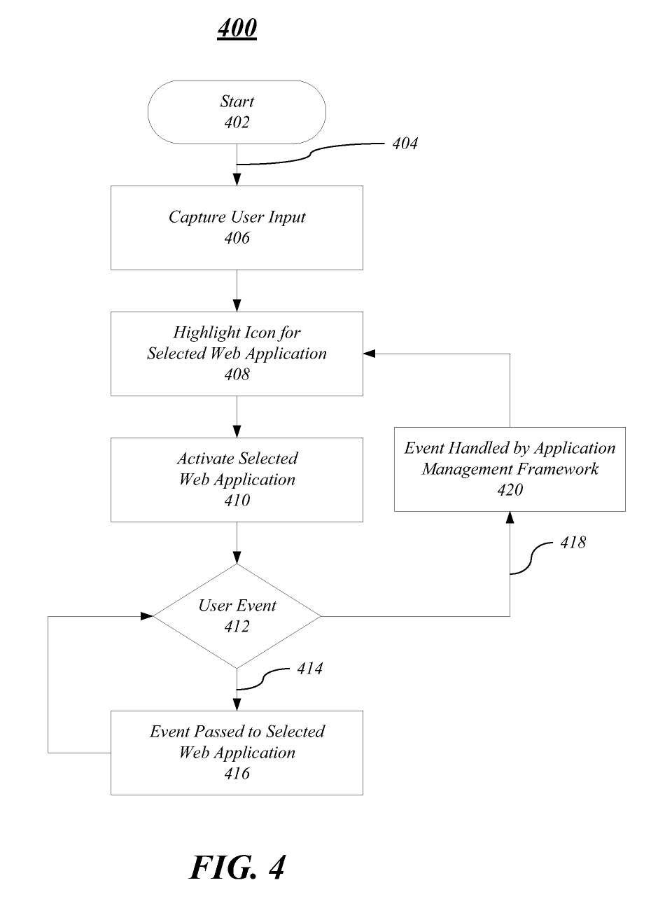

FIG. 4 illustrates one embodiment of a logic flow 400 for handling events by the application management framework 100. The logic flow 400 may be performed by various systems and/or devices and may be implemented as hardware, software, firmware, and/or any combination thereof, as desired for a given set of design parameters or performance constraints. For example, one or more operations of the logic flow 400 may be implemented by executable programming instructions to be executed by a logic device (e.g., computer, processor).

In this embodiment, the application management framework 100 handles one or more events such as user interaction events. After the application management framework 100 and web applications are loaded, the application management framework 100 is ready to handle events (step 402). In this exemplary embodiment, a user may trigger an event by clicking a mouse button on a web application icon (step 404). The application management framework 100 captures the user input (step 406). Then, the application management framework 100 highlights the icon for the selected web application (step 408) and activates the selected web application (step 410). Once a web application is activated, the application management framework 100 responds to the user event (step 412).

If an event takes place within the selected web application (step 414), the application management framework 100 may pass this event to the selected web application (step 416). If an event takes place within the user interface of the application management framework 100 such as the user clicking on a different web application icon (step 418), the application management framework 100 may handle the event (step 420). In this exemplary instance, the application management framework 100 highlights the icon for the selected web application (step 408) and continues the subsequent process of the logic flow 400.

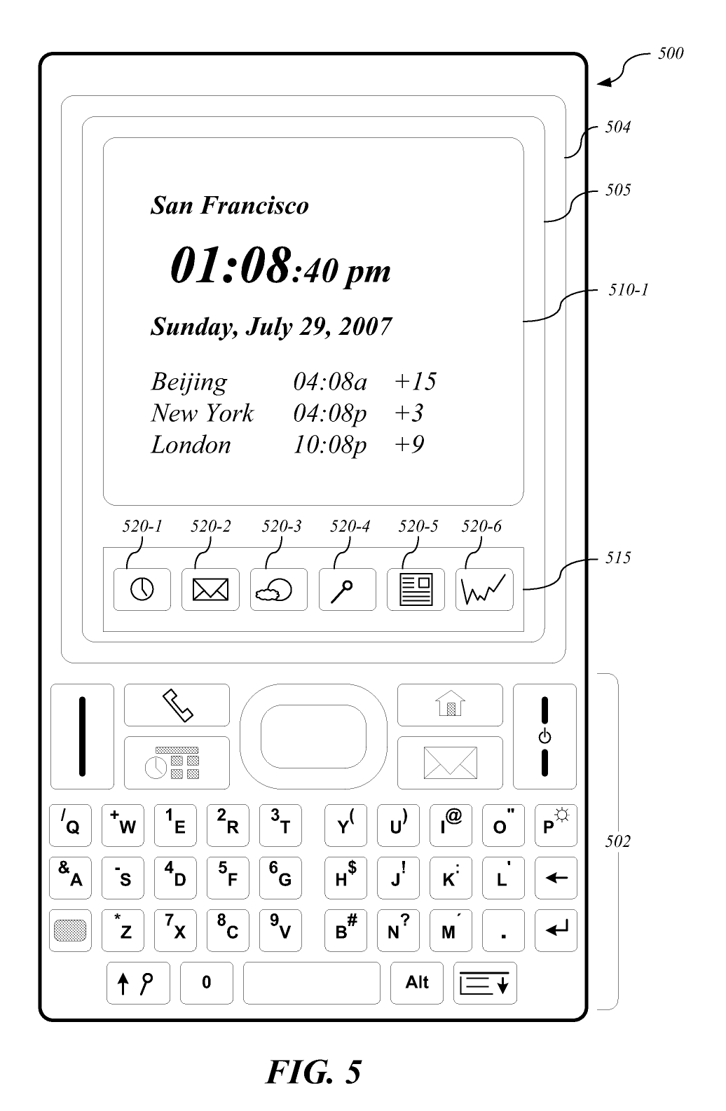

FIG. 5 illustrates a mobile device 500 suitable for implementing various embodiments. As shown, the mobile device 500 may be implemented as a combination handheld computer and mobile telephone, sometimes referred to as a smart phone. It can be appreciated that the mobile device 500 may comprise a computing device having a handheld form factor. While certain embodiments may be described with the mobile device 500 implemented as a smart phone by way of example, the mobile device 500 may be implemented as other types of user equipment (UE) or wireless computing devices such as a computer, laptop computer, ultra-laptop computer, portable computer, handheld computer, palmtop computer, personal digital assistant (PDA), cellular telephone, combination cellular telephone/PDA, smart phone, pager, one-way pager, two-way pager, messaging device, data communication device, gaming device, and so forth. Examples of a mobile computing device may also include computers that are arranged to be worn by a person, such as a wrist computer, finger computer, ring computer, eyeglass computer, belt-clip computer, arm-band computer, shoe computers, clothing computers, and other wearable computers. In one embodiment, for example, the mobile device 500 may be implemented as a smart phone having both wireless voice and/or data communications capabilities, as well as processing capabilities. Although some embodiments may be described with the mobile device 500 implemented as a smart phone by way of example, it may be appreciated that other embodiments may be implemented using other mobile computing devices as well. The embodiments are not limited in this context.

The mobile device 500 generally may be configured to support or provide cellular voice communication, wireless data communication, and computing capabilities in accordance with the described embodiments. The mobile device 500 may comprise various components for providing such capabilities including, for example, a printed circuit board (PCB), one or more processors (e.g., host processor, radio processor), one or more transceivers (e.g., voice communications transceiver, data communications transceiver, GPS transceiver), memory (e.g., volatile or non-volatile memory, removable or non-removable memory, erasable or non-erasable memory, writeable or re-writeable memory), internal and/or external antennas, a rechargeable battery, and others.

The mobile device 500 may provide voice and wireless data communications functionality by communicating with a mobile network such as a Code Division Multiple Access (CDMA) network, Global System for Mobile Communications (GSM) network, North American Digital Cellular (NADC) network, Time Division Multiple Access (TDMA) network, Extended-TDMA (E-TDMA) network, Narrowband Advanced Mobile Phone Service (NAMPS) network, third generation (3G) network such as a Wide-band CDMA (WCDMA) network, CDMA-2000 network, Universal Mobile Telephone System (UMTS) network, and others.

The mobile device 500 also may support wireless wide area network (WWAN) data communications services including Internet access. Examples of WWAN data communications services may include Evolution-Data Optimized or Evolution-Data only (EV-DO), Evolution For Data and Voice (EV-DV), CDMA/1×RTT, GSM with General Packet Radio Service systems (GSM/GPRS), Enhanced Data Rates for Global Evolution (EDGE), High Speed Downlink Packet Access (HSDPA), High Speed Uplink Packet Access (HSUPA), and others.

The mobile device 500 may provide wireless local area network (WLAN) data communications functionality in accordance with the Institute of Electrical and Electronics Engineers (IEEE) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, and others.

The mobile device 500 also may be arranged to perform data communications functionality in accordance with shorter range wireless networks, such as a wireless personal area network (PAN) offering Bluetooth® data communications services in accordance with the Bluetooth® Special Interest Group (SIG) series of protocols, specifications, profiles, and so forth. Other examples of shorter range wireless networks may employ infrared (IR) techniques or near-field communication techniques and protocols, such as electromagnetic induction (EMI) techniques including passive or active radio-frequency identification (RFID) protocols and devices.

The mobile device 500 may comprise various input/output (I/O) interfaces for establishing connections to other devices. The I/O interfaces may comprise, for example, a serial connection port, an IR port, a Bluetooth® interface, a network interface, a WiFi interface, a WiMax interface, a cellular network interface, a wireless network interface card (WNIC), a transceiver, and so forth. Such connections may be implemented using various wired and/or wireless communication media in accordance with the described embodiments. Although certain exemplary embodiments may be described as using a particular communication media by way of example, it may be appreciated that the principles and techniques discussed herein may be implemented using various communication media and accompanying technology.

In some implementations, a connection may comprise a wired connection such as a Universal Serial Bus (USB) connection (e.g., USB host, USB net), Serial Bus Interface (SBI) connection (e.g., FireWire®), or other suitable wired connection to directly connect (e.g., tether, plug in) the mobile device 500 to a device when in close proximity. In other implementations, a connection may comprise a short range wireless connection (e.g., Bluetooth® connection, IR connection) to communicatively couple the mobile device 500 to a device when in close proximity. In some implementations, the a connection may comprise a network connection between the mobile device 500 and a device such as a WiFi connection, WiMax connection, Ethernet connection, cellular network (e.g., 1G/2G/3G) connection, or other suitable packet data or switched connection in accordance with the described embodiments.

The mobile device 500 may comprise various software programs such as system programs and applications to provide computing capabilities in accordance with the described embodiments. Exemplary system programs may include, without limitation, an operating system (OS), device drivers, programming tools, utility programs, software libraries, application programming interfaces (APIs), and so forth. Exemplary operating systems may include, for example, a Palm OS®, Microsoft® OS, Unix® OS, Linux® OS, Symbian OS™, Embedix OS, Binary Run-time Environment for Wireless (BREW) OS, JavaOS, a Wireless Application Protocol (WAP) OS, and others.

The mobile device 500 may provide a variety of applications for allowing a user to accomplish one or more specific tasks. Exemplary applications may include, without limitation, a web browser application (e.g., web browser 105), telephone application (e.g., cellular, VoIP, PTT), networking application, messaging application (e.g., e-mail, IM, SMS, MMS), contacts application, calendar application, word processing application, spreadsheet application, database application, media application (e.g., video player, audio player, multimedia player, digital camera, video camera, media management), location based services (LBS) application, gaming application, and so forth. The applications may comprise or be implemented as executable computer program instructions stored on computer-readable storage media such as volatile or non-volatile memory capable of being retrieved and executed by a processor to provide operations for the mobile device 500. The memory also may implement various databases and/or other types of data structures (e.g., arrays, files, tables, records) for storing data for use by the processor and/or other elements of the mobile device 500.

The mobile device 500 may comprise various components or devices for interacting with an application such as keypad 502 for inputting data and/or commands and a display 504 (e.g., touch-sensitive screen) for presenting one or more user interfaces and receiving user input. It can be appreciated that the mobile device 500 may comprise a variety of components or devices for use with one or more applications such as a stylus, keys (e.g., input keys, preset and programmable hot keys), buttons (e.g., action buttons, a multidirectional navigation button, preset and programmable shortcut buttons), switches, a microphone, speakers, an audio headset, a camera, and so forth.

In accordance with various embodiments, the mobile device 500 may comprise an application management framework 100 implemented by a web browser 105 and including multiple web applications 110-1 through 110-N, as described above. In some implementations, the mobile device 500 may further comprise a WebVM 210 interacting with the application management framework 100.

As shown, the mobile device 500 may present a browser UI 505 as an instance of the web browser 105. The browser UI 505 may display a web application UI 510-1 corresponding to the web application 110-1. In this embodiment, the web application 110-1 may comprise an active clock application or widget, and the web application UI 510-1 may display the local date and time for the mobile device 500 as well as the time in other locations. The browser UI 505 also displays an application management framework UI 515 providing an interface for rapidly switching between the web applications 110-1 through 110-N and receiving a common set of input controls. In various implementations, the web browser 105 may comprise built-in widget controls implemented by the mobile device 500.

In one or more embodiments, the application management framework UI 515 may be implemented as a menu bar comprising a set of icons 520-1 through 520-M, where M is any suitable positive integer value in accordance with the described embodiments. The menu bar of the application management framework UI 515 may be implemented as an application flip tray comprising a page flipping UI such that the user can flip through web applications or widgets very fast in response to a single user event such as single screen touch (e.g., pressing or sliding), button press (e.g., navigation button, a dedicated hard key, a soft key), or interaction with auxiliary controls such as a jog-dial wheel. The user also may select or advance to a particular web application by using any combination of touchscreen events (e.g., touching or pressing on an icon), button events (e.g., mobile device 500 may have dedicated hard or soft key buttons for select, next, and previous), jog-dial events, and screen events (e.g., clicking an icon via a mouse or other random navigation events. In some implementations, the icon tray may auto-hide itself to reserve available screen area. In such cases, the icon tray may only appear momentarily when the user is switching between web applications using the aforementioned events.

As depicted in this exemplary embodiment, the set of icons 520-1 through 520-M includes icons 520-1 through 520-6 for switching between and among active web applications. As shown, the icons 520-1 through 520-6 may be implemented as a clock icon 520-1, a web mail icon 520-2, a weather icon 520-3, a search icon 520-4, a news reader icon 520-5, and a stock listing icon 520-6. The icons 520-1 through 520-6 may correspond, for example, to active web applications or widgets such as web applications 110-1 through 110-6 implemented as clock application 110-1, a web mail application 110-2, a weather application 110-3, a search application 120-4, a news application 110-5, and a stock listing application 110-6. It can be appreciated, however, that the arrangement and order of the icons 520-1 through 520-6 does not necessarily have to correspond to the order of the web applications 110-1 through 110-6. In some embodiments, for example, the user may set preferences, drag and drop, move, add, remove, and/or otherwise customize the set of icons displayed by the application management framework UI 515.

It also can be appreciated the positions and shapes of the components of the application management framework UI 515 are not limited to the embodiment shown in FIG. 5. The attributes of the application management framework UI 515 may be easily changed by modifying graphics elements or layout parameters of the underlying web page and are readily customizable by the web page author. For example, while the application management framework UI 515 is shown as a horizontal bar at the bottom of the web browser UI 505, it also may be placed in a vertical bar along the left side of the web browser UI 505. The application management framework UI 515 also may be hidden at times. As another example, any number of web application icons may be used, each corresponding to web application, as is practical.

Further exemplary embodiments are discussed below in which like reference numerals refer to similar elements as described above. It can be appreciated that any of the features, structures or characteristics described in the context of a particular embodiment are not limited to such embodiment and are not intended to suggest any limitation as to the scope of use or functionality of such embodiment.

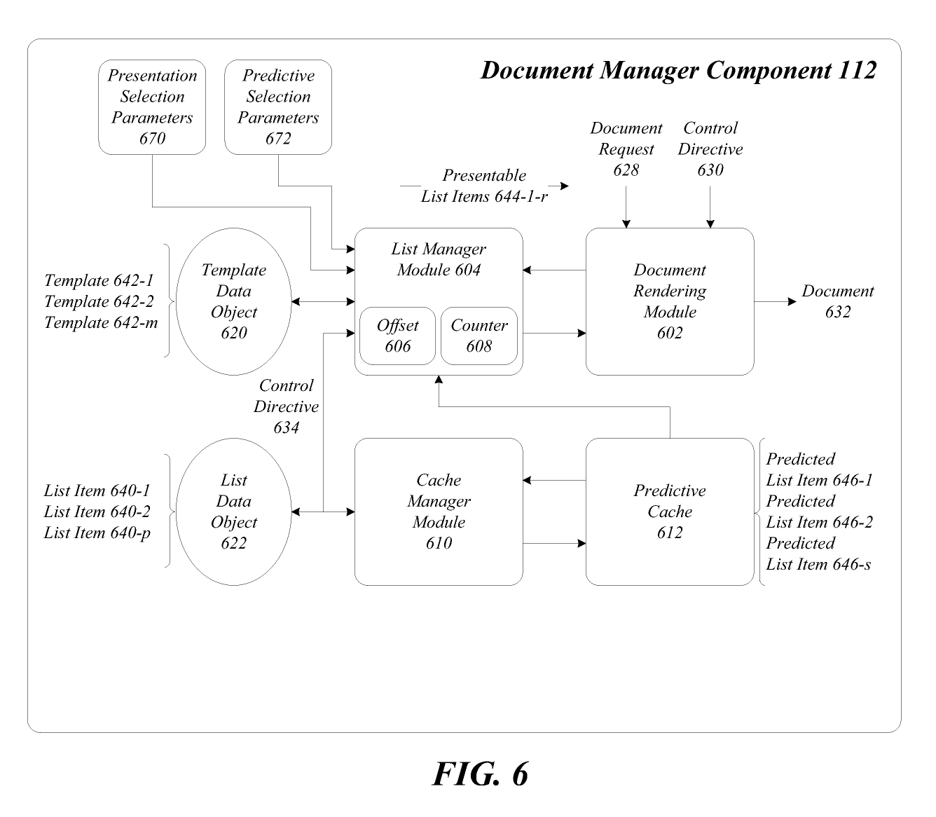

FIG. 6 illustrates a more detailed block diagram for an exemplary implementation of the document manager component 112. As previously described, the application management framework 100 may be implemented within the web browser 105. The application management framework 100 may execute an active web application 110-1 to 110-N. The application management framework 100 may also execute the document manager component 112. Additionally or alternatively, the document manager component 112 may be executed by the web browser 105 or a web application 110-1 to 110-N. The embodiments are not limited in this context.

In the illustrated embodiment shown in FIG. 6, the document manager component 112 may comprise a document rendering module 602, a list manager module 604, a cache manager module 610 and a predictive cache 612. The list manager module 604 may further comprise an offset parameter 606 and a counter parameter 608. One or more data objects or containers may be used to hold data for a document or the various modules of the document manager component 112, such as a template data object 620 and a list data object 622. Although FIG. 6 may show a limited number of modules by way of example, it can be appreciated that a greater or a fewer number of modules may be employed for a given implementation.

The document rendering module 602 may be communicatively coupled to one or more active web applications 110-1 to 110-N, such as active web application 110-1. The document rendering module 602 may be generally arranged to render, display or present documents for an active web application 110-1 to 110-N. An active web application 110-1 may refer to a web application 110-1 to 110-N that is currently being executed by the application management framework 100 and the web browser 105. For instance, the active web application 110-1 may send a document request 628 to generate a document 632 using the document manager component 112.

The document rendering module 602 may be arranged to render, display or present a document 632 for the active web application 110-1 within a display area of an electronic display, such as display 504. The document 632 may comprise any set of information that is suitable for presentation by the web browser 105, such as a web page. The information may be in any suitable format, such as HTML, XHTML, DHTML, XML and so forth. The information may also include one or more hypertext links to provide navigation to other web pages. The document 632 may comprise static web pages or dynamic web pages.

The document 632 may include numerous types of information, which is able to be seen, heard or interact by an end user. The document 632 may include perceived information, such as textual information and non-textual information. Examples of non-textual information may include static images, animated images, audio, video, and so forth. The document 632 may also have interactive information, such as interactive text, interactive illustrations, buttons, and other user interface elements. The document 632 may also have page interoperability information, such as hypertext links, forms, and so forth. The document 632 may further include internal or hidden information, such as comments, metadata, diagramation and style information, scripts, templates, tags, and so forth.

In some cases, many different types of information or content for the document 632 may be organized as a list of items (of varying types and characteristics), which are then rendered in a given format (defined by a template) when the document 632 is presented on the display 504. The document manager component 112 in general, and the list manager module 604 in particular, is designed to handle different types of list items with different characteristics (e.g., height, width, media, etc.). For instance, the document 632 may have, among the other types of data, a set of list items 640-1-p stored by the list data object 622 for placement in the document 632 as indicated by the list tag. Each list item 640-1-p may comprise any type of multimedia information, including media and content that utilizes a combination of different content forms. Examples of multimedia information may include without limitation text, alphanumeric symbols, audio, still images, animation, video, interactivity content forms, symbols, pictures, icons, diagrams, and so forth. Furthermore, each list item 640-1-p may comprise different characteristics, such as having varying sizes, dimensions, data types, data schemas, data structures, and so forth. The set of list items 640-1-p may further comprise an ordered list or an unordered list. An ordered list is a list of items where each item is automatically prefixed by an indication of its position in the list. An unordered list is a list of items where each item is prefixed by a fixed symbol, or nothing. A list-style-type implies the prefixes to be equal or changing, and overrides the distinction between an ordered list and unordered list.

It is worthy to note that although some embodiments describe the operations of the document manager component 112 as implementing predictive caching techniques for list items from a list, it may be appreciated that the predictive caching techniques may be applied to any type of information or content forming a part of the document 632. For example, the document manager component 112 may use predictive caching techniques to accelerate caching for multi-dimensional arrays of data, hypertext links, scripts, programs, files, and so forth. The embodiments are not limited in this context.

In one embodiment, for example, the active web application 110-1 may generate content for the document 632 in the form of HTML content. Embedded within the HTML content may comprise a special purpose tag that reserves a place in the document 632 for a set of list items. The special purpose tag may be referred to herein as a list tag. An example of an implementation for a list tag suitable for use with embodiments may be as follows:

<div x-luna-element=“List”></div>

The DIV tag reserves a place in the document 632 for the list items. The embodiments are not limited, however, to this example.

The document rendering module 602 may be arranged to render, display or present the set of list items 640-1-p for the document 632 for the active web application 110-1 within a display area of the display 504 using one or more container templates or list templates 642-1-m stored by the template data object 620. Each list template 642-1-m may provide a format for each of the list items 640-1-p. Additionally or alternatively, the template data object 620 may include a container template that provides a format for a list as a whole, reserving a place for the item content. An example of a list template 642-1-m suitable for use with embodiments may be as follows:

<h1>My List</h1>
#{listitems}
or
<h3>#{data}</h3><br/>

The HTML template shown above provides an exemplary format for the list items 640-1-p. The embodiments are not limited, however, to this example.

When rendering the document 632 for presentation by the display 504, the document rendering module 602 may identify a list tag embedded in the document 632. When the document rendering module 602 identifies a list tag (e.g., a DIV tag), the document rendering module 602 may call the list manager module 604 to process the list items 640-1-p corresponding to the list tag and stored by the list data object 622.

The list manager module 604 may be communicatively coupled to the document rendering module 602. The list manager module 604 may be generally arranged to perform list management operations for the document rendering module 602. In particular, the list manager module 604 may store, retrieve, and otherwise manage the list items 640-1-p stored by the list data object 622. For instance, the list manager module 604 may pull data from the list data object 622, such as the list items 640-1-p, and delivers them to the document rendering module 602 for insertion into the rendered document 632 using one of the templates 642-1-m. An example result of the rendered document 632 may appear as follows:

<h3>One</h3><br/>
<h3>Two</h3><br/>
<h3>Three</h3><br/>
.
.
.

Different templates 642-1-m may result in different appearances of the list items 640-1-p within the document 632.

The list manager module 604 may handle two general categories of list items from the set of list items 640-1-p. The first category may be one or more presentable list items 644-1-r from the set of list items 640-1-p. The second category may be one or more predicted list items 646-1-s from the set of list items 640-1-p. In general, the presentable list items 644-1-r may include those list items that are to be currently displayed by the display 504, while the predicted list items 646-1-s may include those list items that are predicted or likely to be displayed by the display 504 at some future point in time.

The list manager module 604 may be arranged to select a set of presentable list items 644-1-r from the set of list items 640-1-p stored by the list data object 622 for current presentation within a display area for the display 504. For instance, the document rendering module 602 may begin rendering the document 632 in response to the document request 628 provided by an active web application 110-1. Assume the list items 640-1-p ready for display by the document 632 needs more screen space than is available for the display 504. In this case, the list manager module 604 will select a set (or subset) of presentable list items 644-1-r from the list 640-1-p for immediate display on the display 504. The list manager module 604 may retrieve the presentable list items 644-1-r from the list data object 622, and send the presentable list items 644-1-r to the document rendering module 602 for presentation as part of the document 632 on the available display area for the display 504. Additionally or alternatively, the list manager module 604 may retrieve the presentable list items 644-1-r from other memory units (e.g., a display cache) when the presentable list items 644-1-r have previously been displayed.

In some cases, the list manager module 604 may be arranged to select the set of presentable list items 644-1-r from the list data object 622 for presentation within the display area for the display 504 based on one or more presentation selection parameters 670. The list manager module 604 may select the set of presentable list items 644-1-r based available display area for the display 504. The list manager module 604 may perform the selection operations using one or more presentation selection parameters 670. The presentation selection parameters 670 may provide identifiers for a particular presentation selection technique to be used by the list manager module 604.

The presentation selection parameter 670 may identify a presentation selection technique for selecting a predefined number of presentable list items 644-1-r. In this case, the dimensions (e.g., height, width, or depth) of the display area for the display 504 may be known, and dimensions for the list items 640-1-p may also be known, and a predefined number of presentable list items 644-1-r may be calculated using these known dimensions. For instance, the known dimensions may indicate that 20 list items from the list items 640-1-p are to be selected to form the set of presentable list items 644-1-r.

The presentation selection parameter 670 may identify a presentation selection technique for measuring dimensions for the display area of the display 504 to gauge a number of list items that are to be selected from the list items 640-1-p to form the set of presentable list items 644-1-r. When the list items 640-1-p are of varying dimensions, the list manager module 604 may perform computations for each contiguous list item 640-1-p to select the set of presentable list items 644-1-r that will fit into the measured display area of the display 504. It may be appreciated that the measured display area of the display 504 may be static or dynamic. Furthermore, it may be appreciated that the measured display area of the display 504 may comprise a subset of the full amount of display area provided by the display 504.

The presentation selection parameter 670 may identify a presentation selection technique for inserting spacers before and after displayed content. The spacers may be of uniform size when the list items 640-1-p are of uniform size, or of varying sizes when the list items 640-1-p are of varying sizes. In one embodiment, for example, the list manager module 604 may measure a height for each of the list items 640-1-p or presentable list items 644-1-r to get an average height, and use the average height to insert a top spacer and a bottom spacer before and after displayed list items. For instance, if a list has 50 items and list items 10-20 are currently displayed by the display 504, the list manager module 604 may calculate an average height for the displayed list items 10-20, and generate a top spacer for the list items 1-10 and a bottom spacer for list items 21-50. The spacers may be useful, for example, in allowing scrolling techniques (e.g., a scroll bar) to accurately track and change the presented portions of the list items 640-1-p. Adjustment of a scroll position may be accomplished in a number of different ways, such as performing adjustments to the size of the spacers, using a scroller widget to set scroll offset to scroll the page, and so forth.

The list manager module 604 may be arranged to select a set of predictive list items 646-1-s from the list data object for future presentation within a display area for the display 504. The list manager module 604 may utilize a predictive cache algorithm to identify certain list items from the set of list items 640-1-p stored by the list data object 622 that has a higher probability of being displayed on the display 504, and form a set of predicted list items 646-1-s from the set of list items 640-1-p. The list manager module 604 may then instruct the cache manager module 610 to move, transfer or otherwise cache the predicted list items 646-1-s from storage media with slower access times used to store the list data object 622 to storage media with faster access times used to store the predictive cache 612.

The list manager module 604 may be arranged to select the set of predictive list items 646-1-s from the list data object 622 for future presentation within the display area for the display 504 based on one or more predictive selection parameters 672. The predictive selection parameters 672 may control how many list items are to be selected from the list items 640-1-p and stored in the predictive cache 612. The predictive selection parameters 670 may provide identifiers for a particular predictive selection technique to be used by the list manager module 604.

The predictive selection parameter 672 may indicate a predictive selection technique for utilizing a default number of predicted list items 646-1-s. In this case, the list manager module 604 may select a defined number of predicted list items 646-1-s from the set of list items 640-1-p, and send instructions to the cache manager module 610 to cache the predicted list items 646-1-s from the list data object 622 to the predictive cache 612. The cache manager module 610 may utilize a cache replacement algorithm to make additional room for the predicted list items 646-1-s when memory resources for the predictive cache 612 are insufficiently low.

The predictive selection parameter 672 may indicate a predictive selection technique for utilizing control directives from an operator to determine a suitable number of predicted list items 646-1-s. For instance, the predictive selection parameter 672 may represent a scroll speed for the document 632. The scroll speed may be used to predict a rate by which the list items 640-1-p are likely to be displayed by the display 504. The rate may be used to compute a number of predicted list items 646-1-s to store in the predictive cache 612 in anticipation of presentation by the display 504.

The predictive selection parameter 672 may indicate a predictive selection technique for utilizing various performance characteristics of a device (e.g., computing device 200, mobile device 500, and so forth) or service to determine an appropriate number of predicted list items 646-1-s. For instance, the predictive selection parameter 672 may represent a latency value in retrieving data from a memory resource, processing or computational speed provided by a processor used to process the data, available types of memory resources, and so forth. The list manager module 604 may use one or more such performance characteristics to compute a number of predicted list items 646-1-s to store in the predictive cache 612 in anticipation of presentation by the display 504.

The list manager module 604 may be arranged to select the set of predicted list items 646-1-s from the list data object 622 for future presentation within the display area for the display 504, with each of the predicted list items 646-1-s contiguous to one or more of the presentable list items 644-1-r. In addition to generating a particular number of predicted list items 646-1-s, the predictive selection parameters 672 may also represent a predictive selection technique for selecting which of the list items 640- 1-p are to be selected. For instance, the predictive selection parameters 672 may indicate that the data having the highest probability of further presentation on the display 504 may comprise that data that is adjacent to, adjoining to, or otherwise contiguous with the data currently being displayed by the display 504. In this case, the list manager module 604 may identify and select all data surrounding a portion of displayed data, and instruct the cache manager module 610 to cache the surrounding data (e.g., list items before and after the ones currently displayed) in the predictive cache 612. Additionally or alternatively, the list manager module 604 may further identify and select data contiguous to the predicted list items 646-1-s, and so on, with a particular depth of contiguous list items away from the presentable list items 644-1-r comprising a configurable parameter.

When a user operates an input device to scroll from the displayed data towards a set of surrounding data in a given spatial direction (e.g., up, down, left, right), the list manager module 604 may load the surrounding data from the predictive cache 612 rather than the slower memory used by the list data object 622. Accordingly, a user may experience reduced latency when attempting to scroll through the document 632 for the active web application 110-1, particularly since the boundary of the document 632 exceeds the display area available for the display 504.

The list manager module 604 may be arranged to send a control directive 634 to load the set of predicted list items 646-1-s from the list data object 622 to the predictive cache 612. Once the list manager module 604 selects the predicted list items 646-1-s, the list manager module 604 may instruct the cache manager module 610 to cache the predicted list items 646-1-s from the list data object 622 to the predictive cache 612 using the control directive 634. The list manager module 604 continues this process until all the list items 640-1-p stored by the list data object 622 have been displayed or cached. The list manager module 604 may utilize the offset parameter 606 and the counter parameter 608 to keep track of how many list items from the set of list items 640-1-p have been already loaded.

The cache manager module 610 may be communicatively coupled to the list manager module 604 and the predictive cache 612. The cache manager module 610 may be generally arranged to perform cache operations under the direction of the list manager module 604. For instance, the cache manager module 610 may be operative to receive the control directive 634 from the list manager module 604. The cache manager module 610 may retrieve the set of predicted list items 646-1-s from the list data object 622. The cache manager module 610 may store the set of predicted list items 646-1-s in the predictive cache 612. The cache manager module 610 may also perform routine cache management operations, such as suitable cache replacement algorithms, cache coherency algorithms, cache backup algorithms, and other common cache management techniques.

The cache manager module 610 and the predictive cache 612 may be implemented using any number of caching techniques. A cache may, on average, reduce memory access times. A cache may generally refer to a collection of data duplicating original values stored elsewhere or computed earlier, where the original data is expensive (e.g., usually in terms of access time) to fetch or compute relative to reading the cache. A cache is a block of memory for temporary storage of data likely to be used again. The processor and hard drive frequently use a cache, as do web browsers and web servers. A cache is made up of a pool of entries. Each entry has a datum (a nugget of data) which is a copy of the datum in some backing store. Each entry also has a tag, which specifies the identity of the datum in the backing store of which the entry is a copy. When the cache client (a processor, web browser, operating system, web application program, application management framework) wishes to access a datum presumably in the backing store, it first checks the cache. If an entry can be found with a tag matching that of the desired datum, the datum in the entry is used instead. This situation is known as a cache hit. So, for example, a web browser program might check its local cache on disk to see if it has a local copy of the contents of a web page at a particular URL. In this example, the URL is the tag, and the contents of the web page is the datum. The percentage of accesses that result in cache hits is known as the hit rate or hit ratio of the cache. The alternative situation, when the cache is consulted and found not to contain a datum with the desired tag, is known as a cache miss. The previously uncached datum fetched from the backing store during mis-handling is usually copied into the cache, ready for the next access.

The predictive cache 612 may be implemented using various types of memory units, storage media, or computer-readable media. For instance, the predictive cache 612 may be implemented as memory closer to a processor, such as an L1 or L2 memory cache stored on the same die as the processor, or accessible via a high-speed memory bus. In some cases, the predictive cache 612 may be implemented as volatile (e.g., RAM) or non-volatile memory (e.g., ROM or flash memory). In various embodiments, the predictive cache 612 and the list data object 622 may use different types of memory, with the memory unit used for the predictive cache 612 having faster memory access times than the memory unit used for the list data object 622. This may result in faster average access times due to different memory speeds and/or specific caching techniques. In other embodiments, the predictive cache 612 and the list data object 622 may be implemented on different portions of the same memory unit, with the predictive cache 612 optimized to store, search and deliver information to the processor faster than the corresponding techniques used for the list data object 622. This may result in faster average access times due to specific caching techniques. The embodiments are not limited to a given type of caching technique implemented for the caching manager module 606 and the predictive cache 612, as long as the average memory access times for the predictive cache 612 are faster than the average memory access times for the list data object 622.

The list manager module 604 may be arranged to receive a control directive 630 to present a predicted list item 646-1-s. The list manager module 604 may retrieve the predicted list item 646-1-s from the predictive cache 612 via the cache manager module 610. The list manager module 604 may send the predicted list item 646-1-s to the document rendering module 602. The document rendering module 602 may present the predicted list item 646-1-s as part of the rendered document 632 within the display area of the display 504. As a user continues to scroll through the document 632, the document manager component 112 may continue to update the predictive cache 612 with predicted list items 646-1-s, to accelerate data retrieval and document rendering operations for the document 632, thereby leading to an enhanced user experience when viewing the document 632 on the relatively smaller display 504 provided by the mobile device 500.

Additionally or alternatively, in some cases the list manager module 604 may modify the list items 640-1-p stored by the list data object 622, thereby treating them as dynamic information rather than static information. In response to user commands (e.g., via the control directive 630), the list manager module 604 may rearrange list items, delete list items, add list items, modify a list item, and so forth. The document rendering module 602 may move displayed list items to accommodate changes to the list items 640-1-p.

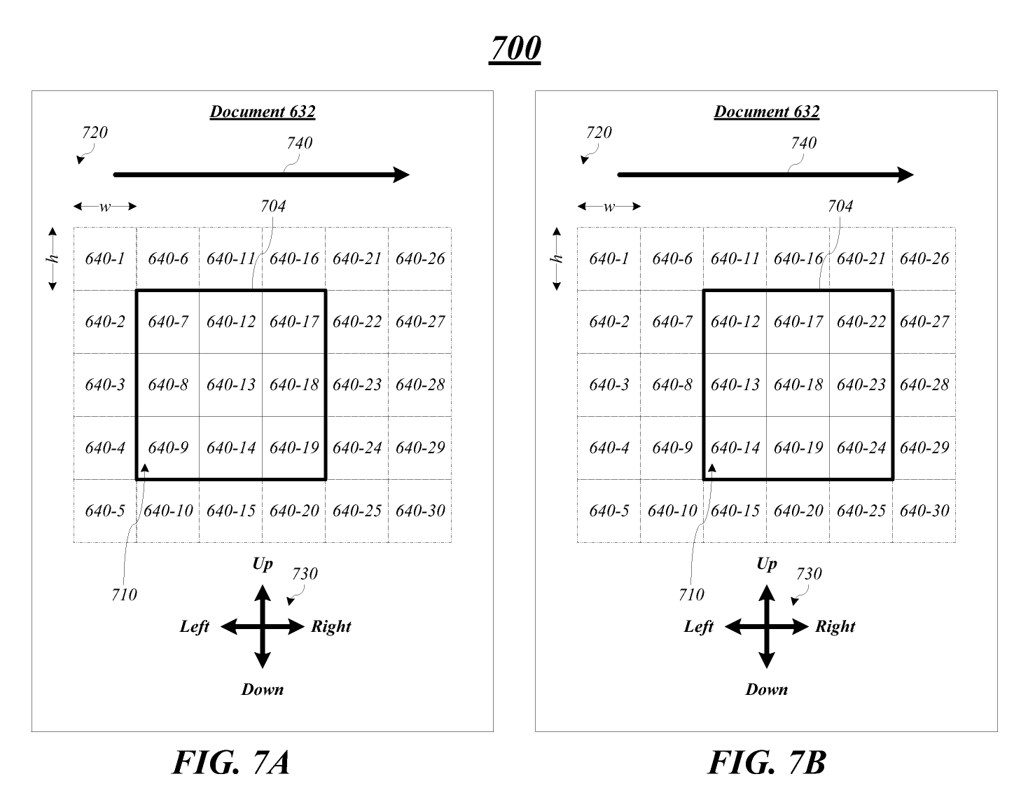

FIGS. 7A and 7B illustrate different user interface views of a web application interface 700. The web application interface 700 may present the document 632. The document 632 may comprise, among other types of information, the set of list items 640-1 to 640-30. The document 632 may comprise a displayed portion 710 that is presented in a display area 704 of the display 504, and a non-displayed portion 720 that is not presented in the display area 704.

In the illustrated embodiment shown in FIG. 7A, the list items 640-7, 640-8, 640-9, 640-12, 640-13, 640-14, 640-17, 640-18 and 640-19 comprise the displayed portion 710 currently being displayed within the display area 704. The list items in the displayed portion 710 may represent, for example, the presentable list items 644-1-r. The list items 640-1, 640-2, 640-3, 640-4, 640-5, 640-6, 640-10, 640-11, 640-15, 640-16, 640-20, 640-21, 640-22, 640-23, 640-24, 640-25, 640-26, 640-27, 640-28, 640-29 and 640-30 comprise the non-displayed portion 720 not being displayed within the display area 704. The list items in the non-displayed portion 720 may represent, for example, some of the predicted list items 646-1-s stored by the predictive cache 612, as well as some of the list items stored by the list data object 622. For instance, assume that the list manager module 604 previously selected all of the list objects in the non-displayed portion 720 that are contiguous to the outer edge list items of the displayed portion 710, namely predicated list items 640-1, 640-2, 640-3, 640-4, 640-5, 640-6, 640-10, 640-11, 640-15, 640-16, 640-20, 640-21, 640-22, 640-23, 640-24 and 640-25, and had them cached in the predictive cache 612. The remaining list items in the non-displayed portion 720 of the document 632 may remain stored in the list data object 622. It may be appreciated that the web application interface 700 may utilize various document viewing tools displayed within the display area 704, such as a horizontal scroll bar and/or a vertical scroll bar (not shown), for example.

In the illustrated embodiment shown in FIG. 7B, assume a user or operator utilizes an input device to operate directional controls 730 of the web application interface 700 to scroll through the various portions of the document 632. The input device for the directional controls 730 may be any suitable input device, such as a touch-screen for the display 504, an m-way navigation button (e.g., a 5-way navigation rocker button), a scroll wheel, audio commands, keys on a thumbboard, and so forth. Although only four directions are shown for the directional controls 730, roughly corresponding to vertical and horizontal movements of the document 632, it may be appreciated that any level of directional granularity may be implemented for the directional controls 730 within a 360 degree field around a center point for the directional controls 730 and/or the document 632. For example, the directional controls 730 may allow a user to scroll towards any of the four corners of the document 632.

Further assume that the operator desires to scroll to the right of the document 632, and utilizes the “Right” directional control 730 to scroll the document 632 towards the right direction as indicated by the arrow 740, thereby exposing some of the list items on the right side of the non-displayed portion 720. The displayed portion 710 now comprises the list items 640-12, 640-13, 640-14, 640-17, 640-18, 640-19, 640-22, 640-23 and 640-24 in the display area 704, while the non-displayed portion 720 now comprises the list items 640-1, 640-2, 640-3, 640-4, 640-5, 640-6, 640-7, 640-8, 640-9, 640-10, 640-11, 640-15, 640-16, 640-20, 640-21, 640-25, 640-26, 640-27, 640-28, 640-29 and 640-30.

In response to a user scrolling to the right, old list items 640-7, 640-8 and 640-9 were left-shifted out of the display area 704, and new list items 640-22, 640-23 and 640-24 were left-shifted into the display area 704. Since the list manager module 604 had accurately predicted that the list items 640-22, 640-23 and 640-24 had a high likelihood of presentation in the display area 704 of the display 504, the list manager module 604 retrieved the predicted list items 640-22, 640-33 and 640-24 from the predictive cache 612 rather than the list data object 622, thereby reducing memory access times, and allowing the document rendering module 602 to render the new portion of the document 632 in less time.

Once the predicted list items 640-22, 640-23 and 640-24 have been read out of the predictive cache 612 and into a display memory for the display 504, the cache manager module 606 may mark the storage locations for the predicted list items 640-22, 640-23 and 640-24 as dirty, thereby releasing the storage locations for use to store other predicted list items from the set of list items 640-1-p remaining in the list data object 622. For instance, the list manager module 604 may select the list items 640-26, 640-27, 640-28, 640-29 and 640-30 as the new predicted list items 646-1-s, and instruct the cache manager module 606 via the control directive 634 to cache the new predicted list items 646-1-s in the predictive cache 612.

As described above, the document manager component 112 may provide several advantages over conventional list management and document rendering techniques. For example, the document manager component 112 may utilize variable sized list items and variable types of lists. In another example, the document manager component 112 may utilize spacers to assist in formatting and scrolling operations for the document 632. This may be particularly useful when the dimensions of the list items are unknown. In yet another example, the document manager component 112 caches those list items that have a higher likelihood of being displayed, such as caching surrounding list items to those already displayed. In still another example, the document manager component 112 may be used across many web applications 110-1 to 110-N, and is not tightly integrated with any one particular application, list item dimension, or list item type. In yet another example, the document manager component 112 uses a finite list of list items to calculate spacers, while at the same time providing a user experience of an infinite loop of data. In still another example, the document manager component 112 may modify the list items, thereby treating them as dynamic information rather than static information. For instance, the document manager component 112 may rearrange list items, delete list items, add list items, modify a list item, and the document manager component 112 will move displayed list items to accommodate changes to the content. The document manager component 112 may provide other features, results and advantages as well, and the embodiments are not limited to these examples.

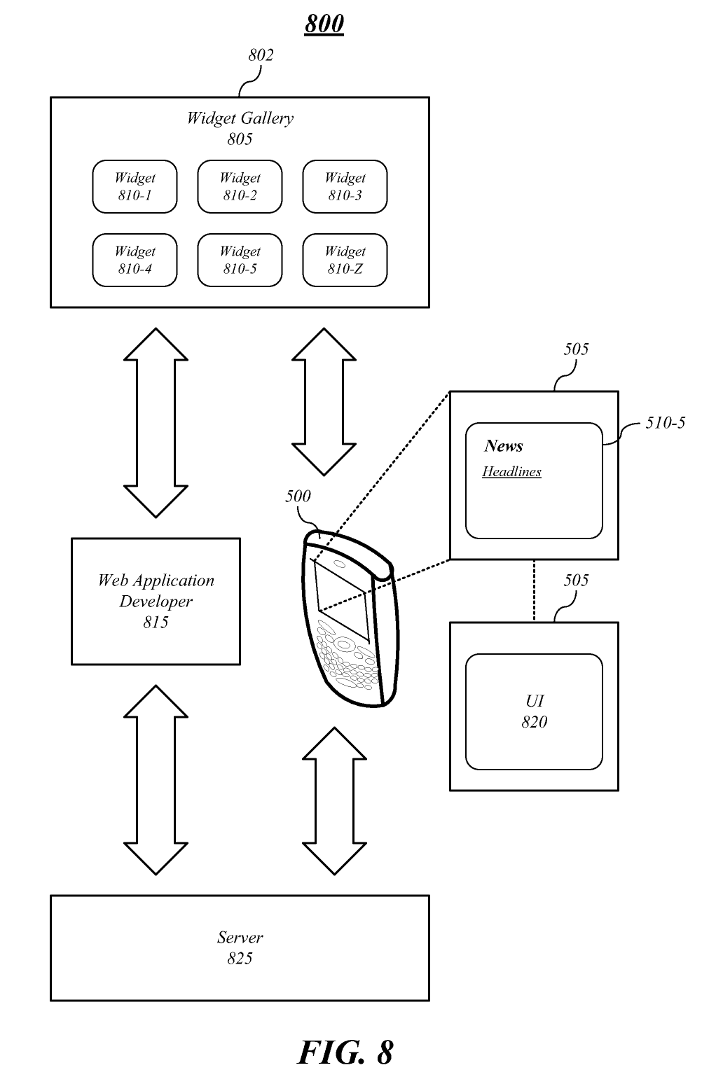

FIG. 8 illustrates an embodiment of a communications system 800 suitable for practicing various embodiments. Although FIG. 8 depicts a limited number of elements for purposes of illustration, it can be appreciated that the communications system 100 may include more or less elements as well as other types of elements in accordance with the described embodiments. Elements of the communications system 800 may comprise physical or logical entities for communicating information implemented as hardware components (e.g., computing devices, processors, logic devices), executable computer program instructions (e.g., firmware, software) to be executed by various hardware components, or combination thereof, as desired for a given set of design parameters or performance constraints.

As shown, the communications system 800 may comprise portal provider 802 implementing a widget gallery 805 for storing widgets 810-1 through 810-Z, where Z is any positive integer value in accordance with the described embodiments. In various implementations a web application developer 815 may upload one or more widgets to the widget gallery 805. The web application developer 815 may be associated with the creator or publisher of a web application. Subsequently, a user may download one or more widgets from the portal provider 802 to the mobile computing device 500.

In some implementations, a user may download various web applications or widgets to the mobile device 500 based on a subscription model so that the user can obtain on-device resident web applications and widgets. In one or more embodiments, the widgets may be transparently upgraded by the portal provider 820 and/or the web application developer 815 hosting the widgets. In some cases, certain web applications or widgets may only be displayed or persist for a short period of time, such as during special events (e.g., entertainment events or sporting events like the Olympics).

In various embodiments, widgets need not be resident on the mobile device 500 and can be served live from a server at the portal provider 802. For example, a user can log into the portal provider 802 and be remembered such as automatically via a web browser cookie or manually via a login and password. The widgets of the user can be streamed, live from the portal provider to the mobile device 500 or a desktop browser.

In various implementations, widgets can be configured on the portal provider 802 and the configuration information may move with the widgets to the mobile device 500. When a user purchases a new device, the previously confirmed widgets of the user can be provisioned to the new device. If the device is stolen or lost, the user's widgets can be remotely removed from or shut down on the old device. In one or more embodiments, the user can use their widgets simultaneously on several different devices or desktop computers. Each device may not show the same widgets. That is, the user can configure different devices to show different widgets. The configuration can be device dependent or can be timed-based, preference-based, and/or based on other factors.

If the widget stores application data or configuration data locally, that data can be backed up to the portal provider 802. For example a user can configure a stock tracker widget to track five particular stocks. This widget then gets provisioned to the mobile device 500. On the mobile device 500, the user changes two of the stock symbols via the widget screen controls. These new stocks are quietly sent back to the portal provider 802 as part of the user's configuration for that widget. This allows other devices provisioned for the user to be, optionally, automatically up-to-date. The backup data may occur automatically and without user intervention. In some cases, the backup data is optional depending on the type of widget application.

In various embodiments, the document manager component 112 and the web browser may display web pages stored by the server 825. The server 825 may comprise, for example, a web server suitable to store a collection of web pages to form a web site. The web server may restrict access only to a private network, e.g. a corporate intranet, or it may publish pages on the World Wide Web (WWW). Web pages may be requested and served from web servers using Hypertext Transfer Protocol (HTTP). Web pages may comprise files of static text stored within the web server's file system (static web pages), or the web server may construct the (X)HTML for each web page when it is requested by a browser (dynamic web pages). Client-side scripting can make web pages more responsive to user input once in the client browser.

In this case, the document manager component 112 may be implemented as part of the web browser 105 to assist in scrolling operations when the document 632 is stored by the web server 825, and in those cases where the document 632 is larger than the display area 704 of the display 504 of the mobile device 500. Rather than moving list items (or other web page content) from the list data object 622 to the predictive cache 612, the document manage component 112 may execute a background thread to move list items from the web server 825 to the predictive cache 612 of the mobile device 500. This may accelerate loading portions of a web page into the display area 704 of the display 504.

It can be appreciated that portal provider 802, the web application developer 815, and the server 825 may comprise or utilize any suitable computing devices having computing capabilities and/or communications capabilities in accordance with the described embodiments. Exemplary computing devices may include, without limitation, a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

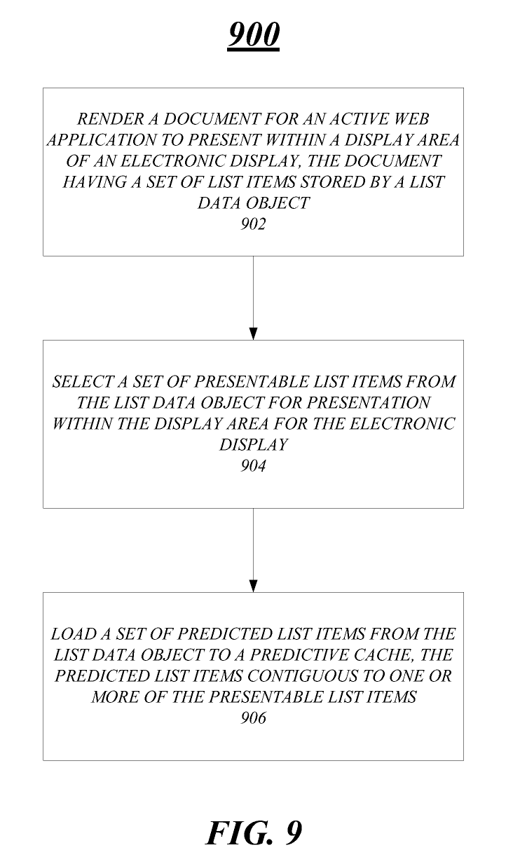

FIG. 9 illustrates one embodiment of a logic flow 900. The logic flow 900 may be representative of some or all of the operations executed by one or more embodiments described herein, such as the document manager component 112.

In the illustrated embodiment shown in FIG. 9, the logic flow 900 may render a document for an active web application to present within a display area of an electronic display, the document having a set of list items stored by a list data object at block 902. For example, the document manager module 602 may render the document 632 for the active web application 110-1 to present within the display area 704 of the electronic display 504 of the mobile device 500. The document 632 may include the set of list items 640-1-p stored by the list data object 622.

In the illustrated embodiment shown in FIG. 9, the logic flow 900 may select a set of presentable list items from the list data object for presentation within the display area for the electronic display at block 904. For example, the list manager module 604 may select the set of presentable list items 644-1-r from the list data object 622 for presentation within the display area 704 for the electronic display 504. The set of presentable list items 644-1-r may comprise, for example, a subset of the list items 640-1-p. The particular set of presentable list items 644-1-r may vary based on the list items currently displayed in the display area 704 (e.g., the displayed portion 710).

In the illustrated embodiment shown in FIG. 9, the logic flow 900 may load a set of predicted list items from the list data object to a predictive cache, the predicted list items contiguous to one or more of the presentable list items, at block 906. For example, the list manager module 604 may select the set of predicted list items 646-1-s from the list data object 622 for likely presentation within the display area 704 for the electronic display 504. The list manager module 604 may send the control directive to the 634 to the cache manager module 610. The cache manager module 610 may receive the control directive 634, and load the set of predicted list items 646-1-s from the list data object 622 to the predictive cache 612. The set of predicted list items 646-1-s may comprise, for example, a subset of the list items 640-1-p. The particular set of predicted list items 646-1-s may vary based on the list items currently not displayed in the display area 704 (e.g., from the non-displayed portion 720). In one embodiment, for example, the predicted list items 646-1-s may be contiguous to one or more of the presentable list items 644-1-r currently being displayed by the display area 704 of the display 504, since such contiguous data has a higher likelihood of being presented in response to scroll operations from a user.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. It also can be appreciated that while a logic flow may illustrate a certain sequence of steps, other sequences of steps may also be performed according to alternative embodiments. Moreover, some individual steps of a logic flow may include multiple sub-steps that may be performed in various sequences as appropriate to the individual step. Furthermore, additional steps may be added or some steps may be removed depending on the particular implementation.

In addition, the logic flow may be implemented by a hardware element, a software element executed by a computer, a firmware element embedded in hardware, or any combination thereof. In various embodiments, the logic flow may comprise, or be implemented as, executable computer program instructions. The executable computer program instructions may be implemented by software, firmware, a module, an application, a program, a widget, a subroutine, instructions, an instruction set, computing code, words, values, symbols or combination thereof. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The executable computer program instructions may be implemented using any suitable high-level, low-level, object-oriented, visual, compiled and/or interpreted programming language in accordance with the described embodiments.

In various embodiments, a logic flow may comprise, or be implemented as, executable computer program instructions stored in an article of manufacture and/or computer-readable storage medium. The article and/or computer-readable storage medium may store executable computer program instructions that, when executed by a computer, cause the computer to perform methods and/or operations in accordance with the described embodiments. The article and/or computer-readable storage medium may be implemented by various systems and/or devices in accordance with the described embodiments. In such embodiments, a computer may include any suitable computer platform, device, system, or the like implemented using any suitable combination of hardware and/or software.

The article and/or computer-readable storage medium may comprise one or more types of computer-readable storage media capable of storing data, including volatile memory or, non-volatile memory, removable or non-removable memory, erasable or non-erasable memory, writeable or re-writeable memory, and so forth. Examples of computer-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other suitable type of computer-readable storage media in accordance with the described embodiments.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A method comprising:
rendering a document for an active web application to present within a display area of an electronic display, the document having a set of list items stored by a list data object;
selecting a set of presentable list items from the list data object for presentation within the display area for the electronic display; and
loading a set of predicted list items from the list data object to a predictive cache, the predicted list items contiguous to one or more of the presentable list items.

2. The method of claim 1, comprising rendering the document for the active web application to present within the display area of the electronic display using a list template to format the list items.

3. The method of claim 1, comprising presenting the document for the active web application within the display area of the electronic display, and the set of presentable list items within the document at a position indicated by a list tag.

4. The method of claim 1, comprising selecting the set of presentable list items from the list data object for presentation within the display area for the electronic display based on one or more presentation selection parameters.

5. The method of claim 1, comprising selecting the set of presentable list items from the list data object for presentation within the display area for the electronic display based on a presentation selection parameter representing an amount of available display area.

6. The method of claim 1, comprising presenting the set of presentable list items within the display area.

7. The method of claim 1, comprising retrieving a predictive caching parameter associated with the list data object.

8. The method of claim 1, comprising selecting the set of predicted list items from the list data object based on one or more predictive caching parameters.

9. The method of claim 1, comprising:
receiving a control directive to present a predicted list item;
retrieving the predicted list item from the predictive cache; and
presenting the predicted list item within the display area of the electronic display.

10. An article of manufacture comprising a storage medium containing instructions that when executed by a processor enable a system to:
present a document for an active web application within a display area of an electronic display, the document having a set of list items stored by a list data object;
select a set of presentable list items from the list data object for presentation within the display area for the electronic display; and
cache a set of predicted list items from the list data object in a predictive cache, the predicted list items contiguous to one or more of the presentable list items.

11. The article of manufacture of claim 10, further comprising instructions that when executed by the processor enable the system to select the set of presentable list items from the list data object for presentation within the display area for the electronic display based on one or more presentation selection parameters.

12. The article of manufacture of claim 10, further comprising instructions that when executed by the processor enable the system to select the set of predicted list items from the list data object based on a predictive caching parameter, the set of predicted list items contiguous to one or more of the presentable list items from the set of presentable list items.

13. The article of manufacture of claim 10, further comprising instructions that when executed by the processor enable the system to retrieve the set of predicted list items from the list data object, and store the set of predicted list items in the predictive cache.

14. The article of manufacture of claim 10, further comprising instructions that when executed by the processor enable the system to receive a control directive to present a predicted list item within the display area of the electronic display, retrieve the predicted list item from the predictive cache, and present the predicted list item within the display area of the electronic display.

15. A mobile computing device, comprising:
a web browser;
an application management framework implemented within the web browser, the application management framework to execute an active web application, the application management framework comprising:
a document rendering module communicatively coupled to the active web application, the document rendering module operative to present a document for the active web application within a display area of an electronic display, the document having a set of list items stored by a list data object; and
a list manager module communicatively coupled to the document rendering module, the list manager module operative to select a set of presentable list items from the list data object for current presentation within the display area for the electronic display, select a set of predictive list items from the list data object for future presentation within the display area for the electronic display, and send a control directive to load the set of predicted list items from the list data object to a predictive cache.

16. The mobile computing device of claim 15, the list manager module operative to select the set of presentable list items from the list data object for presentation within the display area for the electronic display based on one or more presentation selection parameters.

17. The mobile computing device of claim 15, the list manager module operative to select the set of predicted list items from the list data object for future presentation within the display area for the electronic display, with each of the predicted list items contiguous to one or more of the presentable list items.

18. The mobile computing device of claim 15, the list manager module operative to select the set of predictive list items from the list data object for future presentation within the display area for the electronic display based on one or more predictive selection parameters.

19. The mobile computing device of claim 15, comprising a cache manager module communicatively coupled to the list manager module and the predictive cache, the cache manager module operative to receive the control directive from the list manager module, retrieve the set of predicted list items from the list data object, and store the set of predicted list items in the predictive cache.

20. The mobile computing device of claim 15, the list manager module operative to receive a control directive to present a predicted list item, retrieve the predicted list item from the predictive cache, and present the predicted list item within the display area of the electronic display.
